(19) United States
(12) Patent Application Publication
(10) Pub. No.: US 2025/0294649 A1
(43) Pub. Date: Sep. 18, 2025

(54) COOKING APPLIANCE

(71) Applicant: LG ELECTRONICS INC., Seoul (KR)

(72) Inventors: Wontae KIM, Seoul (KR); Hag Soo KIM, Seoul (KR); Jeongkil KIM, Seoul (KR); Sangcheol LEE, Seoul (KR); Chi Woo KANG, Seoul (KR); Taeyoon YOON, Seoul (KR)

(21) Appl. No.: 19/077,268

(22) Filed: Mar. 12, 2025

(30) Foreign Application Priority Data
Mar. 13, 2024 (KR) 10-2024-0034934

(51) Int. Cl. H05B 6/64

(52) U.S. Cl. CPC H05B 6/6423; H05B 6/6426

(57) ABSTRACT

An invention relating to a cooking appliance will be disclosed. The disclosed invention is characterized in that: a rear space section is disposed at the back side of a cooking chamber inside a main body to be communicated with an exhaust port, and an exhaust guide member forms a rear guide flow path that guides the flow of air discharged from a wind blowing part toward the exhaust port, wherein the rear guide flow path is disposed at the rear space portion.

### CROSS-REFERENCE TO RELATED APPLICATION(S)

This application claims priority under 35 U.S.C. § 119 to Korean Application No. 10-2024-0034934, filed on Mar. 13 2024, whose entire disclosure is hereby incorporated by reference.

### BACKGROUND

### 1. Field

The present invention relates to a cooking appliance, and more particularly, to a cooking appliance providing both a cooking function and a hood function.

### 2. Background

A cooking appliance is a type of home appliance for cooking food and is installed in a kitchen space to cook the food based on an intention of a user. Such cooking appliance may be classified in various ways depending on a heat source used, a shape, and a type of fuel.

When classifying the cooking appliance based on a type of cooking the food, the cooking appliance may be classified into an open cooking appliance and a closed cooking appliance depending on a shape of a space where the food is placed. The closed cooking appliance includes an oven, a microwave, and the like, while the open cooking appliance includes a cooking top, a hob, and the like.

The closed cooking appliance is a cooking appliance that shields the space where the food is located and cooks the food by heating the shielded space. In the closed cooking appliance, a cooking chamber, that is the space in which the food is placed and which is shielded when the food is to be cooked, is provided to the inside of the main body. Such cooking chamber becomes a space where the food is actually cooked. The cooking chamber is heated by providing a heat source to the internal or external space of the cooking chamber.

Among the closed cooking appliances, a microwave oven is a cooking device that uses electricity to generate microwaves, which penetrate the food to be cooked inside the cooking chamber, heating it by causing molecular movement therein.

Microwave ovens are kitchen utensils that heat the inside and outside of food simultaneously by irradiating it with high-frequency waves from a magnetron, and they are widely used due to their advantages, such as high thermal efficiency, which greatly reduces the cooking time of food, a reduction in the loss of nutrients during the cooking, defrosting, and reheating processes of food, and the capability of directly cooking the food stored in a container.

Recently, microwave ovens with a hood function, also called as OTR (Over the range) type microwave ovens, have been released. The hood-cum-microwave oven has a hood function that discharges air (hereinafter, referred to as “cooking fumes”) containing foreign substances generated during the process of cooking the food on a cooking appliance installed below it to the outside, or discharges it indoors after filtering it.

This hood-cum-microwave oven is equipped with a fan for sucking in and discharging air. This fan is typically disposed at the top side of the cavity forming the cooking chamber. That is, in the hood-cum-microwave oven, the fan is usually disposed at a position higher than the cavity.

However, in the case where the fan is disposed at such position, the distance between the fan and the suction port disposed at the lower end of the hood-cum-microwave oven is greater than the vertical length of the cavity. As the distance between the suction port and the fan increases, the cooking fumes collection performance of the hood-cum-microwave oven inevitably decreases. This is because the flow rate of the suction airflow generated by the fan would be reduced inversely proportional to the square of the distance from the fan.

Further, when the fan is disposed at the aforementioned position, the vertical length of the entire hood-cum-microwave oven is inevitably increased. As the vertical length of the hood-cum-microwave oven increases as described above, there is a high possibility that when the hood-cum-microwave oven is installed in the upper storage cabinet, the hood-cum-microwave oven will protrude further downward than the upper storage closet.

If the hood-cum-microwave oven protrudes further downward than the upper storage cabinet, it would not only look aesthetically bad, but also the distance between the cooking top installed under the upper storage cabinet and the hood-cum-microwave oven would be smaller.

In the case where the hood-cum-microwave oven protrudes toward the lower side of the upper storage cabinet, the distance between the cooking top and the hood-cum-microwave oven would be smaller, which may lead to problematic situations, such as, where the hood-cum-microwave oven blocks the view of the user using the cooking top, and where the cooking region of the cooking top is smaller.

### BRIEF DESCRIPTION OF THE DRAWINGS

Embodiments will be described in detail with reference to the following drawings in which like reference numerals refer to like elements, and wherein:

FIG. 1 is a perspective view illustrating a cooking appliance according to a first embodiment of the present invention.

FIG. 2 shows the opening state of a cooking chamber of the cooking appliance illustrated in FIG. 1.

FIG. 3 is a bottom view illustrating the bottom of the cooking appliance shown in FIG. 1.

FIG. 4 is a rear perspective view illustrating the cooking appliance shown in FIG. 1 with the cabinet removed.

FIGS. 5 and 6 are rear perspective views showing the cooking appliance illustrated in FIG. 4 with the rear plate removed.

FIG. 7 is a rear view of the cooking appliance illustrated in FIG. 6.

FIG. 8 is a perspective view showing a rear fan assembly illustrated in FIG. 6 in a separated state.

FIG. 9 is a perspective view showing a corner fan assembly illustrated in FIG. 6 in a separated state.

FIG. 10 is a rear perspective view showing the flow path forming member illustrated in FIG. 6 in a separate state.

FIG. 11 is a rear view showing the air flow state in the cooking appliance according to the first embodiment of the present invention.

FIG. 12 is a rear perspective view showing a first state of the cooking appliance according to the first embodiment of the present invention.

FIG. 13 is a view showing the air flow state in the cooking appliance illustrated in FIG. 12.

FIG. 14 is a rear perspective view showing a second state of the cooking appliance according to the first embodiment of the present invention.

FIG. 15 is a view showing the air flow state in the cooking appliance illustrated in FIG. 14.

FIG. 16 is a rear perspective view showing a third state of the cooking appliance according to the first embodiment of the present invention.

FIG. 17 is a view showing the air flow state in the cooking appliance illustrated in FIG. 16.

FIG. 18 is an enlarged view showing the corner fan assembly and its surroundings in a magnified state.

FIG. 19 is a rear perspective view showing a support member illustrated in FIG. 18 in a separate state.

FIG. 20 is a view showing the state in which external air flows into an electrical component chamber through a cold air inflow port.

FIGS. 21 to 23 are views showing the flow state of air flowing into the electrical component chamber.

FIG. 24 is a view showing the flow state of air flowing into a lower corner space section through a connecting flow path member from an upper corner space section.

FIG. 25 is a rear perspective view showing the intake and exhaust states of a cooking appliance according to the first embodiment of the present invention.

FIG. 26 is a rear perspective view showing the air flow state inside the cooking appliance illustrated in FIG. 25.

FIG. 27 is a plan view showing a region around a common exhaust port illustrated in FIG. 25 in a magnified state.

FIG. 28 is an enlarged view showing a exhaust duct and its surroundings in a magnified state.

FIG. 29 is a cross-sectional side view showing the side shape of the exhaust duct.

FIG. 30 is a rear view showing the location of a rear fan assembly relative to the location of a third exhaust port.

FIG. 31 is a rear view showing the state in which an exhaust guide member is installed inside the cooking appliance.

FIG. 32 is a cross-sectional side view showing the internal structure of the cooking appliance illustrated in FIG. 31.

Additionally, FIG. 33 is a rear perspective view showing the state in which the cabinet and the rear plate are removed from the cooking appliance illustrated in FIG. 31.

FIG. 34 is a rear view of the cooking appliance illustrated in FIG. 33.

FIG. 35 is a plan view of the cooking appliance illustrated in FIG. 33.

FIG. 36 is a cross-sectional side view showing a portion of the cooking appliance illustrated in FIG. 31 in a magnified state.

FIG. 37 is a rear view of the cooking appliance illustrated in FIG. 31.

FIG. 38 is an enlarged view showing a portion of the cooking appliance illustrated in FIG. 37 in a magnified state.

FIG. 39 is a rear view showing a rear plate and an exhaust guide member in a separate state.

FIG. 40 is a front view showing the rear plate and the exhaust guide member in a separate state.

FIG. 41 is a rear perspective view of the cooking appliance showing another example of the exhaust guide member.

FIG. 42 is a front view showing the rear plate and the exhaust guide member illustrated in FIG. 41 in a separate state.

### DETAILED DESCRIPTION

The purposes, features and advantages described above will be described in detail below with reference to the accompanying drawings, so that a person having ordinary knowledge in the technical field to which the present invention pertains can easily practice the technical idea of the present invention. In describing the present invention, if it is determined that a detailed description of a known technology related to the present invention may unnecessarily obscure the gist of the present invention, the detailed description thereof will be omitted. Hereinafter, preferred embodiments of the present invention will be described in detail with reference to the accompanying drawings. In the drawings, like reference numerals are used to refer to like or similar components.

Although the terms “first”, “second”, and so on are used to describe various components, these components are not limited by these terms. These terms are merely used to distinguish one component from another component, and unless specifically stated to the contrary, it should be understood that a first component may also be a second component.

The present invention may not be limited to embodiments disclosed below, and various changes may be made and the present invention may be implemented in various different forms. The present embodiment is provided solely to ensure that the disclosure of the present invention is complete and to fully inform those skilled in the art of the scope of the invention. Therefore, it should be understood that the present invention is not limited to the embodiments disclosed below, but includes all changes, equivalents or substitutes included in the technical idea and the scope of the present invention, as well as substitution of components of one embodiment with components of another embodiment and addition of components.

The attached drawings are only for easy understanding of the embodiments disclosed herein, and the technical ideas disclosed herein are not limited by the attached drawings. Further, it should be understood that the present invention includes all modifications, equivalents or substitutions that fall within the technical concept and scope of the present invention. In drawings, components may be expressed exaggeratedly large or small in size or thickness for convenience of understanding or the like, but the scope of protection of the present invention should not be interpreted as limited by the same.

The terms used herein are merely used to describe specific implementations or embodiments, and are not intended to limit the present invention. Further, singular expressions include plural expressions, unless the context clearly dictates otherwise. Herein, terms such as “comprise”, “include”, “have”, “be provided with”, “composed of”, and the like are intended to indicate the existence of features, numbers, steps, operations, components, parts, or combinations thereof described herein. That is to say, it should be understood that terms such as “comprise”, “include”, “have”, “be provided with”, “composed of”, and the like as used herein do not exclude in advance the presence or addition of one or more other features, numbers, steps, operations, components, parts, or combinations thereof.

Terms including ordinal numbers, such as first, second, and the like, may be used to describe various components, but the components are not limited by the terms. The above terms are used only for the purpose of distinguishing one component from another.

When a first component is described as being “connected” or “coupled” to a second component, it should be understood that the components may be directly connected or coupled to each other, but a third component may be interposed between the components. On the other hand, when it is described that the first component is “directly connected” or “directly coupled” to the second component, it should be understood that there are no other components interposed therebetween.

When a first component is described to be “on top of” or “under” a second component, it is understood that the first component may be disposed in contact with a top surface (or a bottom surface) of the second component, as well as a third component may be interposed therebetween.

Unless otherwise defined, all terms used herein, including technical or scientific terms, have the same meaning as commonly understood by a person of ordinary skill in the technical field to which the present invention pertains. Terms defined in commonly used dictionaries should be interpreted as having a meaning consistent with the meaning in the context of the related technology, and unless explicitly defined in the present application, should not be interpreted in an ideal or excessively formal sense.

When a cooking appliance is placed on the floor for use, a side on which a door is installed, relative to a center of the cooking appliance is defined as a front side. Therefore, a direction of opening the door and entering the cooking appliance becomes a rearward direction. For convenience, a direction between the front side and a rear side may be referred to as a first direction. Then, the front side may be referred to as one side in the first direction, and the rear side may be referred to as the other side in the first direction.

Additionally, the direction of gravity may be defined as a down direction, and a direction opposite to the direction of gravity may be defined as an up direction.

In addition, a horizontal direction orthogonal to the front and rear direction of the cooking appliance, that is, a width direction of the cooking appliance when viewing the cooking appliance in front of the door thereof, may be referred to as a left and right direction. For convenience, the left and right direction may be referred to as a second direction. Thus, a right side may be referred to as one side in the second direction, and a left side may be referred to as the other side in the second direction.

In addition, the width direction of the cooking appliance may be referred to as a lateral direction. Then, a right side may be referred to as one lateral side, and a left side may be referred to as the other lateral side.

In addition, the up and down direction described above may be referred to as a third direction. Then, the up direction may be referred to as one side in the third direction, and the down direction may be referred to as the other side in the third direction.

Additionally, the up and down direction described above may be referred to as a vertical direction. Then, both the front and rear direction and left and right direction, that is, both the first direction and the second direction may be referred to as a horizontal direction.

Throughout the present document, “A and/or B” means A, B, or A and B, unless otherwise specified, and “C to D” means equal to or greater than C and equal to or smaller than D unless otherwise specified.

### [Overall Structure of Cooking Appliance]

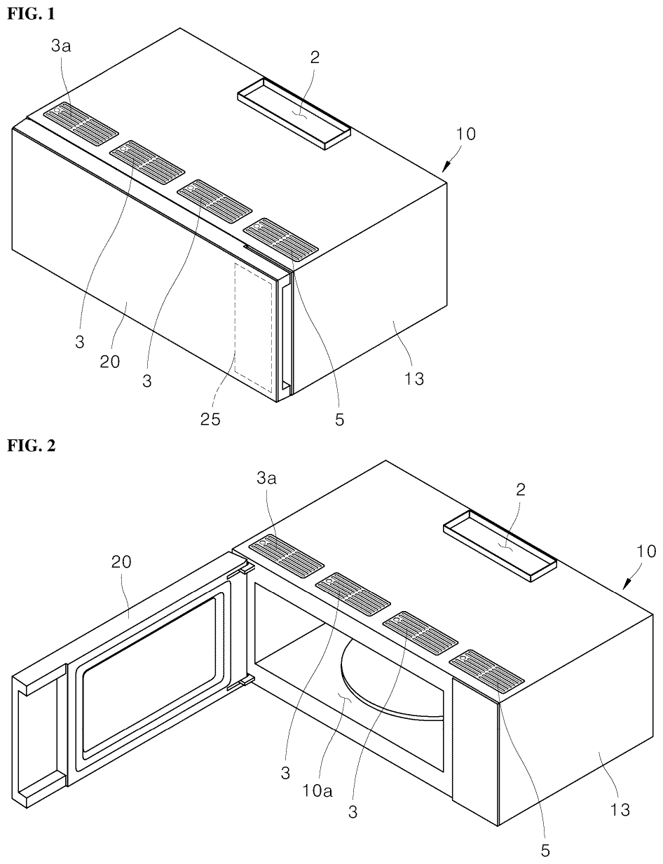

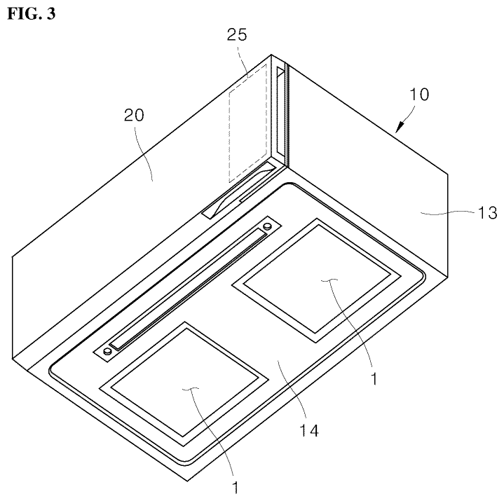

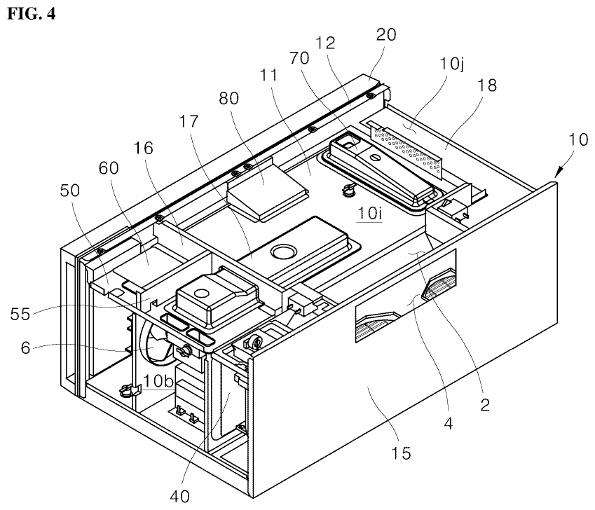

FIG. 1 is a perspective view illustrating a cooking appliance according to a first embodiment of the present invention, and FIG. 2 shows the opening state of a cooking chamber of the cooking appliance illustrated in FIG. 1. Additionally, FIG. 3 is a bottom view illustrating the bottom of the cooking appliance shown in FIG. 1, and FIG. 4 is a rear perspective view illustrating the cooking appliance shown in FIG. 1 with the cabinet removed.

Referring to FIGS. 1 to 4, the cooking appliance according to an embodiment of the present invention has an exterior formed by a main body 10. The main body 10 may be provided in a form that includes an approximately rectangular parallelepiped shape, and may be formed of a material having a predetermined strength to protect a number of components installed in its internal space. This main body 10 may include a cavity 11, a cabinet 13, and a base plate 14.

The cavity 11 may form the internal frame of the main body 10. This cavity 11 may be formed in a form of a hexahedron with the front side open. Inside the cavity 11, a cooking chamber 10a may be formed. The cooking chamber 10a may be formed in a shape corresponding to the internal shape of the cavity 11, that is, in a form of a hexahedron with the front side open.

The cooking chamber 10a may be formed in a form of a hexahedron with the front side open. With the cooking chamber 10a shielded, cooking may be done while the interior space of the cooking chamber 10a is heated. That is, in the cooking appliance, the interior space of the cooking chamber 10a is the space where food is actually cooked.

In front of the cavity 11, a front plate 12 may be disposed. This front plate 12 may form the front exterior of the main body 10 in front of the cavity 11. As an example, the front plate 12 may be provided in a form of a metal plate with an opening formed therethrough.

The cabinet 13 may form the exterior of the main body 10 outside the cavity 11. This cabinet 13 may cover the top and sides of the cavity 11 to form the exterior of the main body 10.

The base plate 14 may be disposed at the lower side of the cavity 11. This base plate 14 can form the bottom of the cooking appliance, and can cover the cavity 11 at the lower side of the cavity 11.

In addition, the main body 10 may further include a rear plate 15. The rear plate 15 may be disposed at the rear side of the cavity 11. This rear plate 15 can form the rear surface of the cooking appliance, and can cover the cavity 11 at the back side of the cavity 11.

The said rear plate 15 may be formed integrally with the cabinet 13, or may be formed separately from the cabinet 13.

At the front of the main body 10, there may be provided a rotatable door 20 which selectively opens and closes the cooking chamber 10a. The door 20 can open and close the cooking chamber 10a in a side-swing manner in which around one lateral side of the door 20, the other lateral side of the door 20 rotates left and right.

This door 20 may be formed in a form of a hexahedron generally having a predetermined thickness. And, between the main body 10 and the door 20, there may be installed a hinge. The hinge may be disposed on one lateral side of the main body 10 so as to rotatably connect the one lateral side of the door 20 to the main body 10. The door 20 may be rotatably connected to the hinge on the front of the main body 10, and may open and close the cooking chamber 10a by rotating around the hinge.

Additionally, a cooking chamber heat source for heating in the cooking chamber 10a is provided inside the main body 10. The cooking chamber heat source can be implemented with one kind, or can be implemented with two or more kinds.

In this embodiment, the cooking chamber heat source includes, by way of example, a magnetron capable of supplying a high-frequency heat source to the inside of the cooking chamber 10a. With regard to this, the magnetron may be installed inside the main body 10, wherein the installation place may be the top or side of the cooking chamber 10a.

Additionally, inside the main body 10, there may be formed an electrical component chamber 10b, 10c, 10d which is located at the top or side of the cooking chamber 10a within the main body 10. In this embodiment, the magnetron and the electrical component chamber 10b, 10c, 10d is, by way of example, disposed at the side of the cooking chamber 10a. Inside the electrical component chamber 10b, 10c, 10d, electrical components such as a magnetron and a high-voltage transformer may be installed.

Additionally, on the front side of the main body 10, a control panel 25 may be provided. As an example, the control panel 25 may be disposed at the door 20.

The control panel 25 may be formed in a form of a hexahedron having a predetermined internal space, and the front surface of the control panel 25 may be provided with an input part through which a user inputs an manipulation signal to operate the cooking appliance. The input part may be provided with a number of manipulation switches, through which the user can directly input manipulation signals.

As another example, the control panel 25 may be disposed at the front side of the cavity 11. This control panel 25 may be disposed at a region that does not overlap with the cooking chamber 10a in a front and rear direction. For example, the electrical component chamber 10b, 10c, 10d may be disposed at the side of the cooking chamber 10a, and the control panel 25 may be disposed at the front side of the electrical component chamber 10b, 10c, 10d.

In addition, the cooking appliance of the present embodiment may further include wind blowing part 100, 200. And, the main body 10 may be provided with an intake port 1 and an exhaust port 2, 3, 4.

The wind blowing part 100, 200 is accommodated within the cooking appliance, and can suck in cooking fumes through the intake port 1, and can exhaust the sucked cooking fumes to the outside of the cooking appliance through the exhaust port 2, 3, 4.

### [Intake Port, Exhaust Port, Space Section]

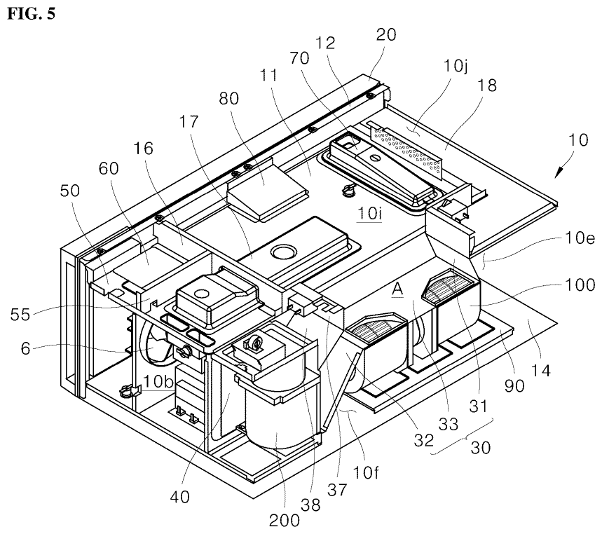

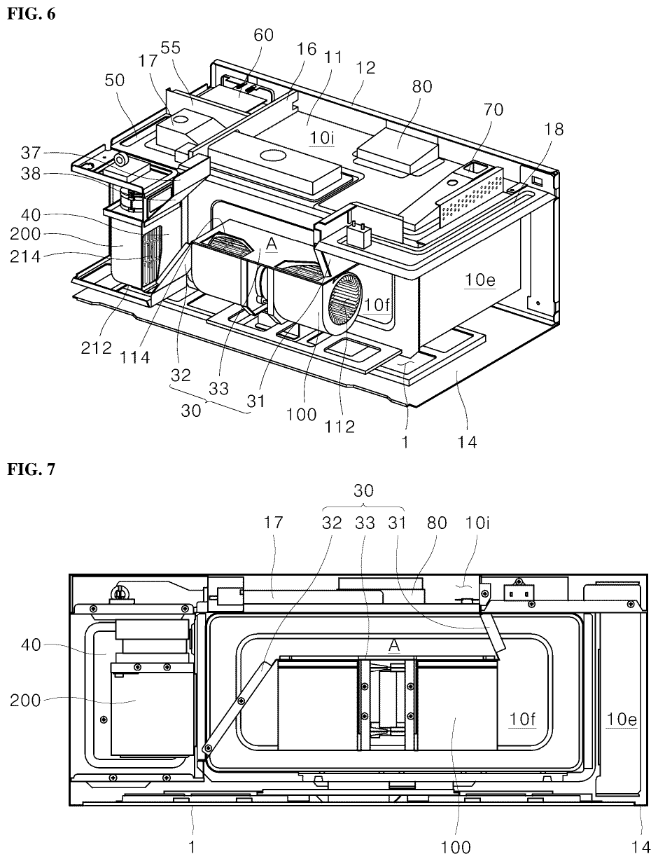

FIGS. 5 and 6 are rear perspective views showing the cooking appliance illustrated in FIG. 4 with the rear plate removed. FIG. 7 is a rear view of the cooking appliance illustrated in FIG. 6.

Referring to FIGS. 3 to 7, the intake ports 1 may be disposed at the bottom of the cooking appliance. As an example, the intake ports 1 may be provided in the base plate 14. These intake ports 1 can form a passage at the lower end of the cooking appliance for cooking fumes to flow into the inside of the cooking appliance. In this embodiment, a pair of intake ports 1 are, by way of example, disposed at the lower side of the wind blowing part 100, 200.

The base plate 14 may be disposed at a predetermined distance downward from the bottom of the cavity 11. Accordingly, a bottom space section (reference numeral is omitted) can be formed between the bottom of the cavity 11 and the base plate 14. By forming the bottom space section in this way, the space required for external air to flow into the cooking appliance through the intake ports 1 can be provided at the upper side of the intake ports 1.

The exhaust port 2, 3, 4 may be disposed at the upper side of the cooking appliance. This exhaust port 2, 3, 4 can form a passage at the top of the cooking appliance for cooking fumes sucked into the inside of the cooking appliance to be exhausted to the outside of the cooking appliance.

In this embodiment, the cooking appliance is, by way of example, provided with the first exhaust port 2, the second exhaust port 3, and the third exhaust port 4.

The first exhaust port 2 and the exhaust port 3 may be disposed at the top surface of the main body 10. These first exhaust port 2 and second exhaust port 3 can form passages at the upper end of the cooking appliance for exhausting cooking fumes sucked into the inside of the cooking appliance to the outside of the cooking appliance.

As an example, the first exhaust port 2 and the second exhaust port 3 may be provided at the top surface of the cabinet 13. These first exhaust port 2 and second exhaust port 3 may be formed to penetrate through the top surface of the cabinet 13 in an up and down direction.

Among these, the first exhaust port 2 may be disposed near the back side of the main body 10. And the second exhaust port 3 may be disposed near the front side of the main body 10. That is, the second exhaust port 3 may be disposed at the side adjacent to the door 20, and may be disposed nearer to the front side compared to the first exhaust port 2.

The first exhaust port 2 can form a passage for exhausting cooking fumes sucked into the inside of the cooking appliance to the outdoors. And the second exhaust port 3 can form a passage for exhausting cooking fumes sucked into the inside of the cooking appliance to the indoors.

As an example, the first exhaust port 2 may be disposed in a region that overlaps in an up and down direction with a top storage cabinet installed on the upper side of the cooking appliance. And the second exhaust port 3 may be disposed at a position protruding forward from the top storage closet.

Additionally, the first exhaust port 2 may be disposed approximately in the lateral center of the main body 10. And, on the front side of the main body 10, a plurality of second exhaust ports 3 may be disposed along the lateral direction.

The first exhaust port 2 disposed approximately in the lateral center of the main body 10 as described above can be connected to an exhaust pipe connected to the outdoors. And the plurality of second exhaust ports 3 arranged in the lateral direction can exhaust cooking fumes toward the upper side of the cooking appliance from the front side of the upper storage closet. At this time, the cooking fumes can be exhausted through the second exhaust port 3 after being filtered inside the cooking appliance.

Like the first exhaust port 2, the third exhaust port 4 can form a passage for exhausting cooking fumes sucked into the inside of the cooking appliance to the outdoors. The third exhaust port 4 may be disposed to face the wall on which the cooking appliance is installed. This third exhaust port 4 can be connected to an exhaust pipe installed on a wall and connected to the outdoors.

The above third exhaust port 4 may be disposed on the rear surface of the cooking appliance, and may be disposed at the upper side of the wind blowing part 100, 200. As an example, the third exhaust port 4 may be provided in the rear plate 15. This third exhaust port 4 may be formed to penetrate through the rear plate 15 in a front and rear direction.

Inside the main body 10, a space section may be formed. This space section may be disposed between the cavity 11 and the cabinet 13.

The space section may be divided into side space sections 10e and a rear space section 10f. The side space sections 10e may be disposed at the laterally opposite sides of the cavity 11, respectively. And the rear space section 10f may be disposed at the back side of the cavity 11.

For example, each of the side space sections 10e may be a space formed between a side of the cavity 11 and a side of the cabinet 13. And the rear space section 10f may be a space formed between the rear surface of the cavity 11 and the rear plate 15.

The side space sections 10e and the rear space section 10f may be communicated with the bottom space section. The side space sections 10e and the rear space section 10f may be connected to the bottom space section in an up and down direction, and may be connected to it in a lateral direction. The intake port 1 can be communicated with the bottom space section, and the side space sections 10e and the rear space section 10f can be communicated with the intake port 1 through the bottom space section.

In any one of the side space sections 10e, the electrical component chamber 10b, 10c, 10d may be disposed. In this embodiment, the electrical component chamber 10b, 10c, 10d are, by way of example, provided in the side space section located at the back side of the control panel 25.

Additionally, in the inside of the main body 10, there may be formed a space that is located at the back side of the cavity 11 and also at the side of the cavity 11. This space may constitute the rear space section 10f, and may constitute the side space section 10e or the electrical component chamber 10b, 10c, 10d.

For example, the space may be disposed at a rear corner portion inside the main body 10. Hereinafter, the space located at the back side of the electrical component chamber 10b, 10c, 10d will be referred to as a corner space section 10g, 10h. The rear space section 10f and the side space sections 10e, more specifically, the rear space section 10f and the electrical component chamber 10b, 10c, 10d, can be communicated with each other through the corner space section 10g, 10h.

The wind blowing part 100, 200 may be disposed in the inside of the main body 10. More specifically, the wind blowing part 100, 200 may be disposed in a space section, that is, a space between the cavity 11 and the cabinet 13. The wind blowing part 100, 200 may include at least one fan assembly 100 or 200.

The fan assemblies 100 and 200 can generate an airflow to draw in cooking fumes from outside the cooking appliance and then exhaust it outside the cooking appliance. These fan assemblies 100 and 200 can cause cooking fumes to flow into the inside of the main body 10 through the intake ports 1, and can exhaust the sucked cooking fumes through the exhaust ports 2, 3, and 4.

At least one of the fan assemblies 100 and 200 provided in the wind blowing part 100, 200 may be disposed in the rear space section 10f. Accordingly, the cooking fumes that has flowed into the main body 10 through the intake ports 1 can pass through the rear space section 10f and then can be exhausted through the first exhaust port 2 or the second exhaust port 3. The specific construction in which the fan assemblies 100 and 200 are disposed will be described later.

Additionally, in the inside of the main body 10, there may be provided a top space section 10i. The top space section 10i may be disposed at the upper side of the cavity 11.

For example, the top space section 10i may be formed between the top surface of the cavity 11 and the top surface of the cabinet 13. This top space section 10i may be connected to the rear space section 10f.

That is, air that has flowed into the rear space section 10f can pass through the top space section 10i to be exhausted outside the cooking appliance through the exhaust port 2, 3, 4. Additionally, air the has flowed into the side space sections 10e can pass through the rear space section 10f and the top space section 10i to be exhausted outside the cooking appliance through the exhaust port 2, 3, and 4.

### [Fan Assembly]

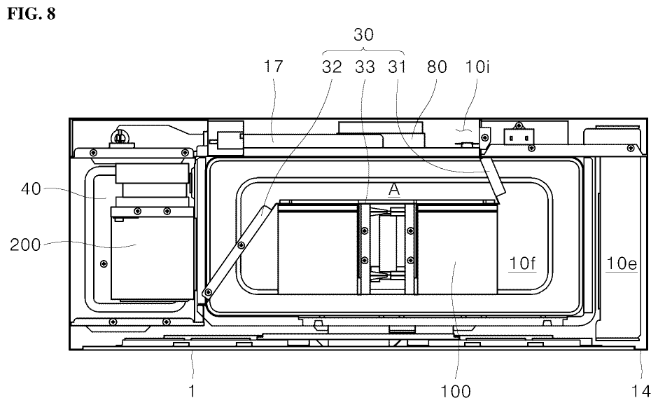

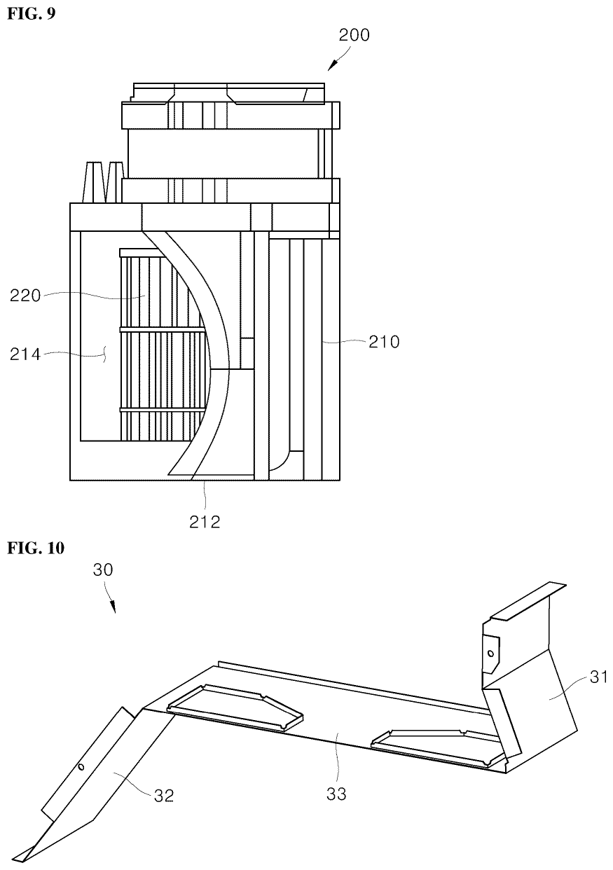

FIG. 8 is a perspective view showing a rear fan assembly illustrated in FIG. 6 in a separated state, and FIG. 9 is a perspective view showing a corner fan assembly illustrated in FIG. 6 in a separated state.

Referring to FIG. 1 and FIGS. 7 to 8, the wind blowing part 100, 200 may include at least one fan assembly 100 or 200. As an example, the wind blowing part 100, 200 may include a rear fan assembly 100.

The rear fan assembly 100 may include a fan housing 110, an impeller 120, and a fan motor.

The fan housing 110 can form the exterior of the rear fan assembly 100, and can accommodate an impeller 120 in its inside. In the side of the fan housing 110, a first suction port 112 may be formed. The first suction port 112 can form a passage in the fan housing 110, through which air outside the rear fan assembly 100 is sucked into the inside of the impeller 120.

In this embodiment, the fan housing 110 is, by way of an example, formed in a shape including a lying cylindrical shape with the opposite sides open, at least one of the open both sides of the fan housing 110 may be provided as the first suction port 112.

In the inside of the fan housing 110, there may be formed an accommodation space for accommodating the impeller 120. And the inner circumferential surface of the fan housing 110 facing this accommodation space may be formed in a curved surface that surrounds the outer circumferential surface of the impeller 120.

A first outlet 114 may be provided in the upper side of the fan housing 110. The first outlet 114 forms a passage through which air sucked into the accommodation space accommodating the impeller 120 is discharged to the outside of the wind blowing part 100, 200.

The first outlet 114 may be formed in a form of penetrating through the fan housing 110 in an up and down direction. Accordingly, air sucked into the fan housing 110 through the first suction port 112 in a lateral direction can be discharged to the upper side of the fan housing 110 through the first outlet 114.

The impeller 120 is provided such that it can rotate around an axis extending in a lateral direction. In the inside of the impeller 120, there is formed a space section into which air is sucked in through a side of the impeller 120.

The impeller 120 may be connected to the rotation shaft of the fan motor. The rotation shaft of the fan motor can rotate around an axis extending in a lateral direction, and the impeller 120 connected to the rotation shaft of the fan motor can rotate around the axis extending in the left and right direction together with the rotation shaft of the fan motor.

The rear fan assembly 100 provided as described above may be disposed inside the main body 10, wherein the disposition location may be at least one of the rear space section 10f and the corner space section 10g, 10h. In this embodiment, the rear fan assembly 100 is, by way of example, disposed in the rear space section 10f.

As an example, the rear fan assembly 100 may be provided in a form of including a pair of impellers 120. This rear fan assembly 100 may be provided in a form in which the fan motor is disposed between a pair of impellers 120 arranged in a lateral direction.

In the rear fan assembly 100, the fan motor can rotate the pair of impellers 120 disposed on opposite sides together. And the impellers 120 can be accommodated respectively inside a pair of fan housings 110 arranged on both opposite sides of the fan motor.

The rear fan assembly 100 including, as described above, one fan motor and a pair of impellers 120 and fan housings 110 can suck in air through the pair of first suction ports 112 respectively disposed on the laterally opposite sides of the rear fan assembly 100, and can discharge air through the pair of first outlets 114 disposed on the upper side of the rear fan assembly 100.

The rear fan assembly 100 may be provided in a form in which the pair of impellers 120 and fan housings 110 are arranged on opposite sides of the fan motor. Hereinafter, the assembly of the impeller 120 and the fan housing 110 will be referred to as a “fan module.” According to this, it can be said that each rear fan assembly 100 is provided in a form in which a pair of fan modules are connected to opposite sides of the fan motor.

The rear fan assembly 100 may be disposed in the rear space section 10f, that is, the space formed between the rear surface of the cavity 11 and the rear plate 15. This rear fan assembly 100 may be disposed in a space communicating with the intake ports 1 and the exhaust port 2, 3, 4, so that it can suck in air through the intake ports 1 and discharge air toward the exhaust port 2, 3, 4.

The wind blowing part 100, 200 of the present embodiment may include a plurality of fan assemblies 100 and 200 arranged in a lateral direction. As an example, the wind blowing part 100, 200 may further include the corner fan assembly 200 as shown in FIGS. 7 and 9. The rear fan assembly 100 and the corner fan assembly 200 may be arranged in the rear space section 10f in a lateral direction.

The corner fan assembly 200 may be provided in a form in which one fan module is connected to a fan motor. As an example, the corner fan assembly 200 may be provided in a form in which one fan module is connected to the lower side of the fan motor.

In this corner fan assembly 200, the impeller 220 can rotate around an axis arranged in an up and down direction. And a second suction port 212 may be disposed in the lower side of the fan housing 210, and a second outlet 214 may be disposed in a side of the fan housing 210.

That is, the corner fan assembly 200 may be provided in a form generally similar to a form in which a half of the rear fan assembly 100 is erected in a vertical direction.

In the rear space section 10f, the rear fan assembly 100 and the corner fan assembly 200 may be disposed together. As an example, the rear fan assembly 100 and the corner fan assembly 200 may be arranged in the rear space section 10f in a lateral direction.

For example, the corner fan assembly 200 may be disposed in the side adjacent to the electrical component chamber 10b, 10c, 10d, and the rear fan assembly 100 may be disposed in the side adjacent to the side space section 10e opposite thereto.

At least a portion of the corner fan assembly 200 may be disposed in the corner space section 10g, 10h. As an example, most of the area of the corner fan assembly 200 may be disposed in the corner space section 10g, 10h, and the second suction port 212 of the corner fan assembly 200 may also be disposed in the corner space section 10g, 10h. The corner fan assembly 200 may be disposed spaced apart from the rear fan assembly 100 by a predetermined distance in a lateral direction.

According to the present embodiment, instead of including only a plurality of rear fan assemblies 100, the wind blowing part 100, 200 may include the rear fan assembly 100 and the corner fan assembly 200 together.

As the rear fan assembly 100 and the corner fan assembly 200 are applied together to the wind blowing part 100, 200 in this way, the lateral length of the entire wind blowing part 100, 200 can be reduced compared to a case where the wind blowing part 100, 200 includes only a plurality of rear fan assemblies 100.

For example, compared to the wind blowing part 100 including a pair of rear fan assemblies 100 arranged in a lateral direction, the lateral length of the wind blowing part 100, 200 including one rear fan assembly 100 and one corner fan assembly 200 can be less.

The corner fan assembly 200 is provided in a form not only in which it includes a portion of the fan modules included in the rear fan assembly 100, but also in which the portion of the fan modules is erected vertically. Therefore, the lateral length of the corner fan assembly 200 can be much shorter than that of the rear fan assembly 100.

Considering this point, the wind blowing part 100, 200 of the present embodiment including such corner fan assembly 200 can be provided in a significantly smaller size compared to a wind blowing part including the rear fan assembly 100 only.

When the wind blowing part 100, 200 of this type is applied to the cooking appliance, the size of the cooking appliance, especially the lateral length of the cooking appliance, can be reduced as the space occupied by the wind blowing part 100, 200 becomes smaller.

Considering this point, when the size of the cooking appliance is slightly small to dispose a plurality of rear fan assemblies 100 inside the cooking appliance, it is believed that the wind blowing part 100, 200 of the present embodiment is very suitable to be employed to such cooking appliance.

Additionally, in this corner fan assembly 200, the second suction port 212 can be disposed in the lower side of the fan housing 210. Accordingly, the second suction port 212 can be disposed at the lowest end of the corner fan assembly 200, and can be disposed very close to the intake port 1 provided at the lower end of the cooking appliance.

Considering that the suction performance of the fan assembly with respect to the output of the fan motor can be significantly improved as the distance between the second suction port 212 and the intake port 1 becomes closer, it can be seen that the suction performance of the corner fan assembly 200 can be significantly improved as the second suction port 212 of the corner fan assembly 200 becomes closer to the intake port 1.

That is, although the performance of the corner fan assembly 200 may be lower than that of the rear fan assembly 100, most of this performance difference can be offset by the performance improvement obtained by shortening the distance between the second suction port 212 and the intake port 1.

Considering these points, the wind blowing part 100, 200 of the present embodiment can be evaluated as being capable of providing a cooking fumes-removal performance of the same level as other types of wind blowing parts while providing an effect of contributing to the miniaturization of the cooking appliance.

The cooking appliance of the present embodiment including the wind blowing part 100, 200 as described above can provide improved cooking fumes-removal performance while maintaining a compact size.

Meanwhile, referring to FIGS. 5 to 7, the rear fan assembly 100 and the corner fan assembly 200 may be disposed to overlap with the cavity 11 in a front and rear direction. That is, the rear fan assembly 100 and the corner fan assembly 200 may be disposed between the upper and lower surfaces of the cavity 11 in an up and down direction.

In order for the air that has flowed into the inside of the main body 10 through the intake port 1 to smoothly move toward the rear fan assembly 100 or the corner fan assembly 200, a predetermined distance needs to be secured between the intake port 1 and both the rear fan assembly 100 and the corner fan assembly 200.

In addition, in order for the air discharged from the rear fan assembly 100 and the corner fan assembly 200 to move smoothly toward the top space section 10i, it is preferable that the rear fan assembly 100 and the corner fan assembly 200 be disposed lower than the top space section 10i.

When the rear fan assembly 100 and the corner fan assembly 200 are disposed higher than the top space section 10i, a problem may occur in that the passage between the first outlet 114 or the second outlet 214 of the rear fan assembly 100 or the corner fan assembly 200 and the top space section 10i becomes too narrow.

Considering this point, in this embodiment, the rear fan assembly 100 and the corner fan assembly 200 are disposed at positions where the rear fan assembly 100 and the corner fan assembly 200 can be appropriately spaced apart from the intake port 1, and the rear fan assembly 100 and the corner fan assembly 200 can be appropriately spaced apart from the top space section 10i.

Accordingly, the smooth air flow from the intake port 1 to the rear fan assembly 100 and the corner fan assembly 200 and the smooth air flow from the rear fan assembly 100 and the corner fan assembly 200 to the top space section 10i can be achieved.

Additionally, the corner fan assembly 200 may be disposed closer to the intake port 1 than to the exhaust port 2, 3, 4. Accordingly, the second suction port 212 of the corner fan assembly 200 can be disposed very close to the intake port 1. As a result, the suction performance of the corner fan assembly 200 having relatively smaller size and lower output compared to the rear fan assembly 100 can be effectively improved.

### [Example of Flow Path Forming Member]

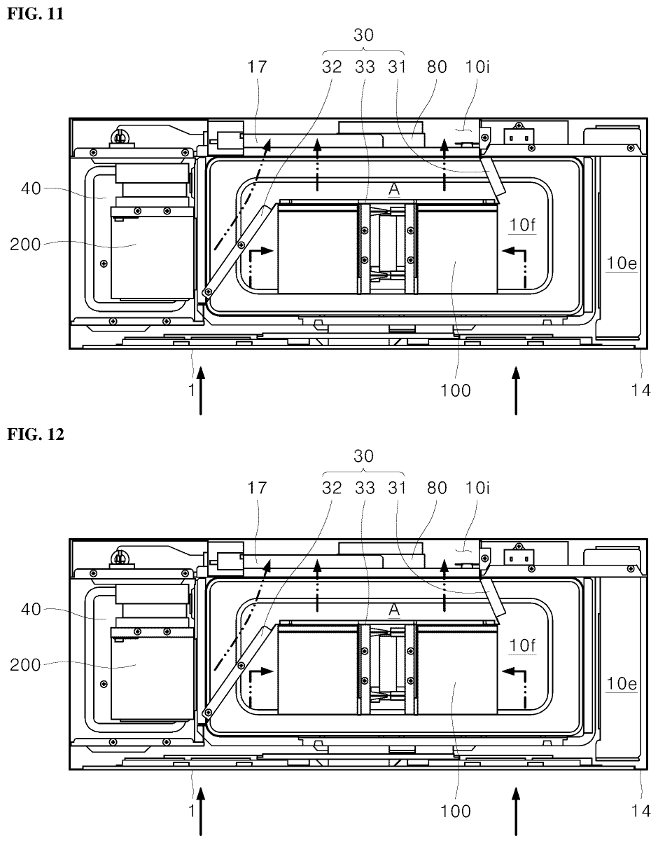

FIG. 10 is a rear perspective view showing the flow path forming member illustrated in FIG. 6 in a separate state, and FIG. 11 is a rear view showing the air flow state in the cooking appliance according to the first embodiment of the present invention.

Referring to FIGS. 5 to 7 and 10, the cooking appliance may include a flow path forming member 30. The flow path forming member 30 is provided to guide the flow of air discharged from the wind blowing part 100, 200.

The flow path forming member 30 may form an exhaust flow path (A) inside the cooking appliance. The exhaust flow path (A) may connect between the wind blowing part 100, 200 and the top space section 10i, and is provided to guide air flow from at least one of the rear fan assembly 100 and the corner fan assembly 200 to the top space section 10i. This exhaust flow path (A) can guide the flow of air discharged from the wind blowing part 100, 200 toward the exhaust port 2, 3, 4.

As an example, the exhaust flow path (A) may be disposed in the rear space section 10f. The entrance of this exhaust flow path (A) can be opened toward the wind blowing part 100, 200. For example, the entrance of the exhaust flow path (A) may be opened toward the first outlet 114 of the rear fan assembly 100 and the second outlet 214 of the corner fan assembly 200. And the exit of the exhaust flow path (A) may be opened toward the top space section 10i.

The exhaust flow path (A) may form inside the cooking appliance a path that guides the air flow from the first outlet 114 of the rear fan assembly 100 to the top space section 10i. In addition, the exhaust flow path (A) may form inside the cooking appliance a path that guides the air flow from the second outlet 214 of the corner fan assembly 200 to the top space section 10i.

As an example, at least a portion of the exhaust flow path (A) may be formed by the first flow path plate 31. The first flow path plate 31 may form a wall that blocks between the first suction port 112 and the first outlet 114 of the rear fan assembly 100.

This first flow path plate 31 may be disposed in the rear space section 10f, and may be disposed in the upper side of the rear fan assembly 100. That is, the first flow path plate 31 may form a wall blocking between the first suction port 112 and the first outlet 114 on the upper side of the rear fan assembly 100.

According to the present embodiment, the rear fan assembly 100 and the corner space sections 10g, 10h may be arranged in the rear space section 10f in a lateral direction. In the rear space section 10f, the first suction ports 112 may be disposed respectively at the laterally opposite sides of the rear fan assembly 100. And the first outlets 114 may be disposed between a pair of first suction ports 112 spaced apart by a predetermined interval in a lateral direction, and may be disposed on the top surface of the rear fan assembly 100.

If one of the pair of first suction ports 112 which is disposed closer to the corner space sections 10g, 10h is referred to as the left first suction port 112, the first flow path plate 31 is provided to form a wall blocking between the first outlet 114 and the right first suction port 112. This first flow path plate 31 may be disposed at a position that is offset from the lateral center of the rear fan assembly 100 toward the right first suction port 112, that is, at a position adjacent to the right first suction port 112.

Hereinafter, the direction toward the electrical component chamber 10b, 10c, 10d along the lateral direction from the lateral center of the cooking appliance is referred to as the left, and the direction toward the side space section 10e located on the opposite side thereto is referred to as the right.

The first flow path plate 31 may form a vertical wall extending upward toward the top space section 10i from the top surface of the rear fan assembly 100 where the first outlets 114 are formed. This first flow path plate 31 can define the right boundary surface of the exhaust flow path (A).

Meanwhile, the cooking appliance of the present embodiment may further include an expansion plate 18. The expansion plate 18 can be disposed to block between the top space section 10i and the rear space section 10f.

At least a portion of the expansion plate 18 may be disposed in the rear space section 10f. At least a portion 18b (hereinafter, referred to as “rear partition”) of the expansion plate 18 disposed at that position may be disposed between the rear fan assembly 100 and the top space section 10i in an up and down direction. Additionally, the rear partition 18b of the expansion plate 18 may be disposed between the rear surface of the cavity 11 and the rear plate 15 in a front and rear direction.

The rear partition 18b of the expansion plate 18 disposed in this manner covers a portion of the rear space section 10f at a position higher than the rear fan assembly 100, and blocks between the portion of the rear space section 10f and the upper space 10i.

In this embodiment, the expansion plate 18 blocks, by way of example, between the right portion of the rear space section 10f and the top space section 10i.

The expansion plate 18 and the rear fan assembly 100 are spaced apart in an up and down direction, so that a lateral passage is formed between the expansion plate 18 and the rear fan assembly 100. The lateral passage formed in this manner can connect the right portion of the rear space section 10f covered by the expansion plate 18 with a portion above the rear fan assembly 100, in which the exhaust flow path (A) is formed.

The first flow path plate 31 may form a vertical wall extending upward toward the expansion plate 18 from the rear fan assembly 100. As an example, the first flow path plate 31 may form a vertical wall connecting between the top surface of the rear fan assembly 100 and a side end of the expansion plate 18. At least a portion of this first flow path plate 31 may protrude upward from the expansion plate 18.

As described above, the first flow path plate 31 connected to the expansion plate 18 can form a vertical wall that blocks the lateral passage formed between the rear fan assembly 100 and the expansion plate 18. That is, the first flow path plate 31 can form a wall in the rear space section 10f, which blocks the air flow between the right portion of the rear space section 10f and the exhaust flow path (A).

Additionally, the flow path forming member 30 may further include a second flow path plate 32. The second flow path plate 32 may form a wall that blocks between the first suction port 112 and the first outlet 114 of the rear fan assembly 100.

The second flow path plate 32 may be disposed at the left side of the rear fan assembly 100. According to this, in a lateral direction, the rear fan assembly 100 can be disposed between the first flow path plate 31 and the second flow path plate 32.

In the lateral direction, the second flow path plate 32 may be disposed between the rear fan assembly 100 and the corner fan assembly 200. This second flow path plate 32 can form a wall that blocks between the first suction port 112 and the first outlet 114, and at the same time, blocks between the second outlet 214 of the corner fan assembly 200 and the first suction port 112 of the rear fan assembly 100.

In the corner fan assembly 200, the second suction port 212 is disposed toward the intake port 1, i.e., to face downward. And the second outlet 214 can be disposed to face toward the rear fan assembly 100, that is, toward a lateral direction, more specifically, toward the right side, and can be connected with the exhaust flow path (A).

The second flow path plate 32 may be disposed in the right side of the second outlet 214 to define the lower boundary surface of the exhaust flow path (A). This second flow path plate 32 can define the lower boundary surface of the exhaust flow path (A) between the rear fan assembly 100 and the corner fan assembly 200. In this regard, the lower boundary surface of the exhaust flow path (A) defined by the second flow path plate 32 can form a slope whose height changes along a lateral direction.

According to the present embodiment, the second outlet 214 may be disposed to face the first suction port 112 which is disposed to face the corner fan assembly 200. And the first doutlet 114 may be disposed higher than the first suction port 112, and may be disposed higher than the second outlet 214.

As an example, the second flow path plate 32 may form a slope extending in a lateral direction from the lower side of the second outlet 214 toward the upper side of the first suction port 112. For example, the second flow path plate 32 may extend slantingly upward in a lateral direction from one lateral end adjacent to the corner fan assembly 200 toward the rear fan assembly 100.

One lateral end of the second flow path plate 32 can be disposed at the lower side of the second outlet 214. For example, the left end of the second flow path plate 32 may be disposed at a position lower than the second outlet 214.

Additionally, the other lateral end of the second flow path plate 32 may be disposed at the upper side of the first suction port 112. For example, the right end of the second flow path plate 32 may be disposed at a position higher than the first suction port 112.

The second flow path plate 32 can form a wall that blocks between the first suction port 112 and the first outlet 114, and between the first suction port 112 and the second outlet 214. In other words, the second flow path plate 32 can form an inclined wall between the rear fan assembly 100 and the corner fan assembly 200, and this wall can not only block between the first suction port 112 and the first outlet 114, but also block between the first suction port 112 and the second outlet 214.

Accordingly, between the rear fan assembly 100 and the corner fan assembly 200, air discharged from the first outlet 114 does not flow into the first suction port 112, and air discharged through the second outlet 214 does not flow into the first suction port 112.

That is, the second flow path plate 32 can form, between the rear fan assembly 100 and the corner fan assembly 200, a wall that blocks the air flow from the first outlet 114 and the second outlet 214 to the first suction port 112.

According to this embodiment, the exhaust flow path (A) can be formed on the left side of the first flow path plate 31 and the upper side of the second flow path plate 32. The intake port 1 may be disposed on the lower side of this exhaust flow path (A). Also, with respect to an up and down direction, the first suction port 112 and the second suction port 212 may be disposed between the intake port 1 and the exhaust flow path (A), and the first outlet 114 and the second outlet 214 may be disposed between the exhaust flow path (A) and the top space section 10i.

The first outlet 114 and the second outlet 214 can be connected with the exhaust flow path (A). The first outlet 114 can be disposed to face upward, so that it can be connected with the exhaust flow path (A). And the second outlet 214 can be disposed to face toward a lateral direction, so that it can be connected with the exhaust flow path (A).

In addition, the second flow path plate 32 may form a flow path that guides an air inflow into the first suction port 112.

As an example, the second flow path plate 32 may be disposed in the upper side of the intake port 1, and may be disposed in the left and upper side of the first suction port 112. This second flow path plate 32 can form the left and upper boundary surfaces of the flow path connecting between the intake port 1 and the first suction port 112. By means of the second flow path plate 32 provided in this manner, air inflow can be effectively guided into the first suction port 112 on the left side of the rear fan assembly 100.

Meanwhile, the flow path forming member 30 may further include a fastening plate 33. The fastening plate 33 may be installed at the rear fan assembly 100.

As an example, the fastening plate 33 can be combined to the top surface of the rear fan assembly 100 while allowing the first outlets 114 to be open upward. This fastening plate 33 may be disposed in the upper side of the first suction port 112, and may be disposed in the upper side of the second suction port 212 and the second outlet 214.

According to the present embodiment, the first flow path plate 31 may be provided in a form of extending upward from the fastening plate 33. Additionally, the second flow path plate 32 may be provided in a form of extending downward from the fastening plate 33. That is, the upper end of the second flow path plate 32 may be connected with the fastening plate 33.

The first flow path plate 31 and the second flow path plate 32 connected with the fastening plate 33 in this manner can be connected to the rear fan assembly 100 via the fastening plate 33.

In addition, the fastening plate 33 can be disposed between the first flow path plate 31 and the second flow path plate 32 to connect the first flow path plate 31 with the second flow path plate 32. As an example, the flow path forming member 30 may be provided in a form in which the first flow path plate 31, the second flow path plate 32, and the fastening plate 33 are formed integrally.

In the flow path forming member 30 provided in this form, the first flow path plate 31 and the second flow path plate 32 do not need to be separately connected to the rear fan assembly 100, and the installation of the first flow path plate 31 and the second flow path plate 32 can be easily and quickly accomplished by the fastening plate 33 being connected to the rear fan assembly 100.

A discharge hole (reference numeral is omitted) may be formed in the fastening plate 33. The first outlet 114 can be exposed to the upper side of the fastening plate 33, i.e., the inside of the exhaust flow path (A), through this discharge hole.

Additionally, the cooking appliance of the present embodiment may further include a support member 40. The support member 40 is provided to support the corner fan assembly 200. At least a portion of this support member 40 may be disposed in the corner space sections 10g, 10h.

As an example, the support member 40 may include a lateral support part 41. The lateral support part 41 may be disposed in a lateral side of the corner fan assembly 200. The lateral support part 41 may form a side surface of the support member 40, more specifically, the right side surface of the support member 40.

The lateral support part 41 may form a vertical wall that covers the corner fan assembly 200 from the side. For example, the lateral support part 41 may form a vertical plane perpendicular to a lateral axis. This lateral support part 41 may form a wall that blocks between the corner fan assembly 200 and the rear fan assembly 100 in the rear space section 10f.

The lateral support part 41 may be disposed between the corner fan assembly 200 and the second flow path plate 32. This lateral support part 41 can define the left boundary surface of the exhaust path (A).

In the lateral support part 41, a discharge hole 41a may be formed. The second outlet 214 can be exposed to the right side of the lateral support part 41, i.e., the inside of the exhaust flow path (A), through this discharge hole.

In addition, the cooking appliance of the present embodiment may further include a connecting flow path forming member 37, 38. The connecting flow path forming member 37, 38 may be disposed at the upper side of the corner fan assembly 200. This connecting flow path forming member 37, 38 can partition the rear space section 10f so that a portion of the rear space section 10f which is neighboring the support member 40 is separated into a connecting flow path member 39.

As an example, the connecting flow path forming member 37, 38 may include a first partition 37 and a second partition 38.

The first partition 37 may form a vertical wall that is disposed to be spaced apart from the support member 40 by a predetermined interval in a lateral side. As an example, the first partition 37 may form a vertical wall that is disposed to be spaced apart from the lateral support part 41 by a predetermined interval in a lateral side. In a lateral direction, the first partition 37 may be disposed between the corner fan assembly 200 and the rear fan assembly 100.

The second partition 38 may form a wall connecting the lateral support part 41 with the first partition 37. As an example, the first partition 37 may be disposed at a position spaced apart from the lateral support part 41 towad the right side by a predetermined distance. The second partition 38 may form a wall connecting between the lower end of the first partition 37 and the lateral support part 41.

As an example, the second partition 38 may be disposed at the upper side of the second flow path plate 32. The left end of this second partition 38 may be connected to the lateral support part 41. Additionally, the left end of the second partition 38 may be disposed spaced apart from the left end of the second flow path plate 32 in an up and down direction with the second outlet 214 interposed therebetween.

As an example, the second partition 38 may form a slope parallel to the second flow path plate 32. This second partition 38 can define the left boundary surface of the exhaust flow path (A) together with the lateral support part 41, and can guide, toward the lateral center of the exhaust flow path (A), the flow of air discharged from the second outlet 214 into the exhaust flow path (A).

The first partition 37 may extend upward from the second partition 38, and may define the left boundary surface of the exhaust flow path (A) together with the lateral support part 41 and the second partition 38. This first partition 37 can guide the flow of air flowing through the exhaust flow path (A) toward the top space section 10i.

When the operation of the wind blowing part 100, 200 begins, a suction airflow for sucking air outside the cooking appliance into the inside of the cooking appliance can be formed, as shown in FIGS. 8 to 10 and FIG. 11. The suction airflow formed in this way acts on the external air to be suctioned through the intake port 1 disposed at the lower end of the cooking appliance. The external air around the intake port 1, i.e. the cooking fumes, can be sucked into the main body 10 through the intake port 1 by the suction airflow acting in this way.

And, the cooking fumes sucked into the main body 10 in this way can flow into the rear space section 10f among the space sections inside the main body 10. In this way, the cooking fumes that has flowed into the rear space section 10f can be sucked into the rear fan assembly 100 and the corner fan assembly 200 through the first suction ports 112 disposed on opposite sides of the rear fan assembly 100 respectively, and through the suction port disposed on the lower side of the corner fan assembly 200.

At this time, air suction into the rear fan assembly 100 can be guided by at least a portion of the flow path forming member 30. Specifically, air suction into the first suction port 112 disposed on the left side of the rear fan assembly 100 can be guided by the second flow path plate 32.

Air sucked into the rear fan assembly 100 and the corner fan assembly 200 can be discharged through the first outlet 114 and the second outlet 214, respectively. The flow of air discharged in this way can be guided by the exhaust flow path (A).

Air discharged from the second outlet 214 of the corner fan assembly 200 can pass through the rear space section 10f via the exhaust flow path (A) to flow toward the top space section 10i. Around the second outlet 214, the exhaust flow path (A) can form a passage inclined right upward from the second exhaust outlet 214.

The right upward passage formed in this manner can have a low resistance to air flow in the exhaust flow path (A), and can minimize flow loss inside the cooking appliance. This right upward passage can be formed by the second flow path plate 32 defining the lower boundary surface of the exhaust flow path (A) on the right side of the second outlet 214 and the connecting flow path forming member 37, 38 defining the left boundary surface of the flow path.

Additionally, air discharged from the first outlet 114 of the rear fan assembly 100 can pass through the rear space section 10f via the exhaust flow path (A) to flow toward the top space section 10i. At this time, the exhaust flow path (A) can guide the air flow so that the air discharged through the first outlet 114 can flow toward the top space section 10i without being spread to the surroundings.

### [Air Suction and Outlet Structure of Cooking Appliance]

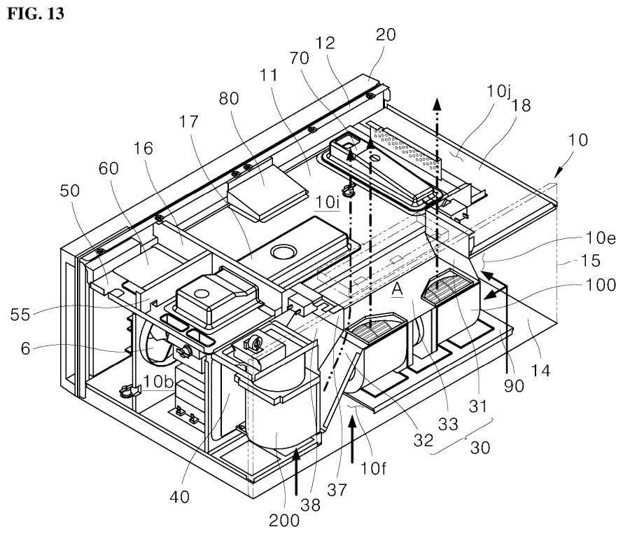

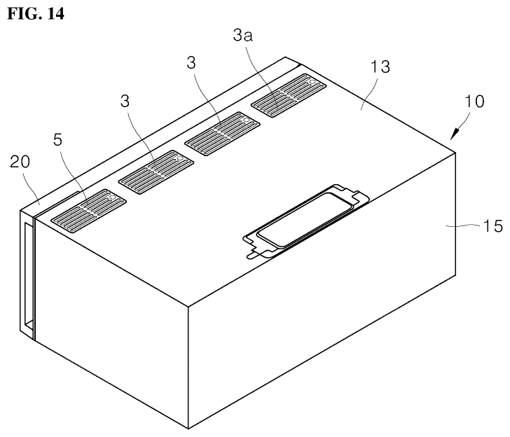

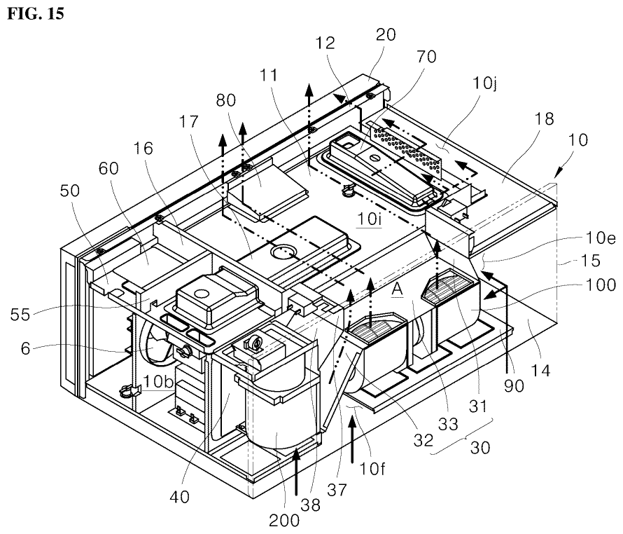

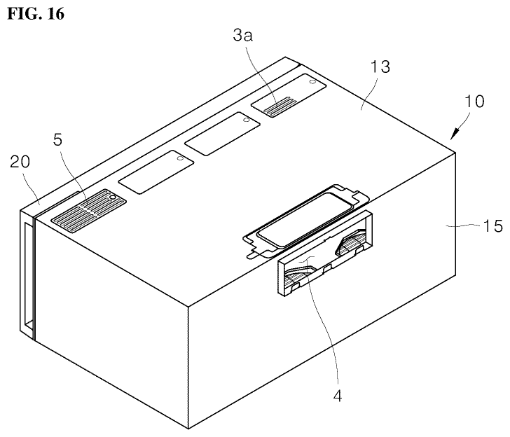

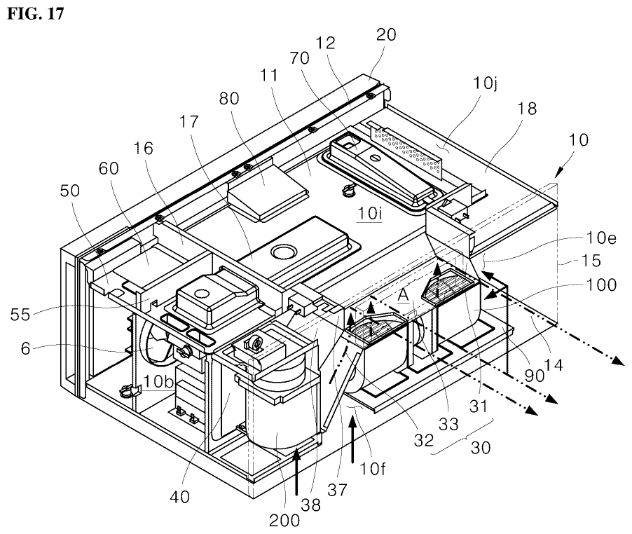

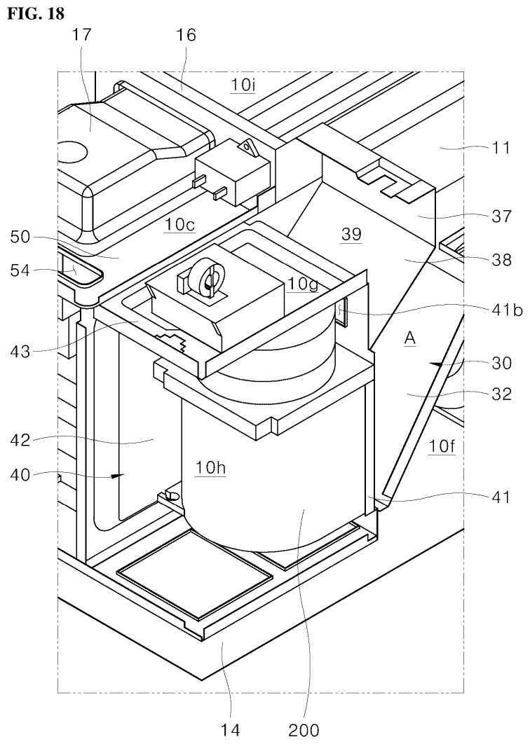

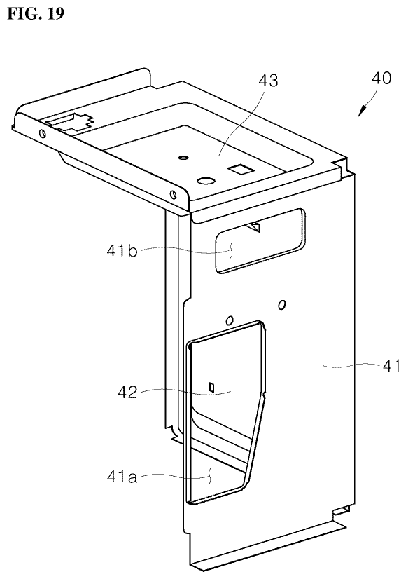

FIG. 12 is a rear perspective view showing a first state of the cooking appliance according to the first embodiment of the present invention, and FIG. 13 is a view showing the air flow state in the cooking appliance illustrated in FIG. 12. Further, FIG. 14 is a rear perspective view showing a second state of the cooking appliance according to the first embodiment of the present invention, and FIG. 15 is a view showing the air flow state in the cooking appliance illustrated in FIG. 14. Further, FIG. 16 is a rear perspective view showing a third state of the cooking appliance according to the first embodiment of the present invention, and FIG. 17 is a view showing the air flow state in the cooking appliance illustrated in FIG. 16.

Hereinafter, the air suction and outlet structure of the cooking appliance according to the present embodiment will be described with reference to FIGS. 11 to 17.

Referring to FIGS. 11 to 13, the intake port 1 may be provided at the lower end of the cooking appliance, and the exhaust port may be provided at the upper end of the cooking appliance. The first exhaust port 2 may be disposed at the top surface of the cabinet 13, wherein the disposition place may be near the back side of the cooking appliance, and the second exhaust port 3 may be disposed so as to be near the front side of the cooking appliance. And the third exhaust port 4 may be disposed at the back side of the cooking appliance, wherein the disposition location may be the rear plate 15.

The wind blowing part 100, 200 may include the rear fan assembly 100 and the corner fan assembly 200, and the rear fan assembly 100 may be disposed in the rear space section 10f. And the corner fan assembly 200 may be disposed in the rear space section 10f or the corner space sections 10g, 10h.

When the operation of the rear fan assembly 100 and the corner fan assembly 200 begins, the suction airflow can be formed to suck air outside the cooking appliance into the inside of the cooking appliance. The suction airflow formed in this way acts on the external air through the intake port 1 disposed at the lower end of the cooking appliance. The external air around the intake port 1, i.e. the cooking fumes, can be sucked into the main body 10 through the intake port 1 by the suction airflow acting in this way.

And, the cooking fumes sucked into the main body 10 in this way can flow into the rear space section 10f through the bottom space section. For example, the cooking fumes that has flowed into the bottom space section can flow into the rear space section 10f and the corner space sections 10g, 10h.

The cooking fumes that has flowed into the rear space section 10f can be sucked into the inside of the rear fan assembly 100 through the first suction ports 112 disposed on the opposite sides of the rear fan assembly 100 respectively. In this way, the cooking fumes sucked into the rear fan assembly 100 can be discharged upward through the first outlets 114 disposed in the upper side of the rear fan assembly 100.

Cooking fumes that has flowed into the corner space sections 10g, 10h can be sucked into the inside of the corner pan assembly 200 through the second suction port 212 disposed at the lower side of the corner pan assembly 200. The cooking fumes sucked into the corner fan assembly 200 in this way can be discharged in a lateral direction of the corner fan assembly 200 through the second outlet 214 disposed at the side of the corner fan assembly 200.

The rear space section 10f can connect the intake port 1 disposed at the lower side of the bottom space section with the top space section 10i. And in this rear space section 10f, the exhaust flow path (A) can be formed. The flow of cooking fumes discharged from the rear fan assembly 100 and the corner fan assembly 200 can be guided toward the top space section 10i by the exhaust flow path (A).

When, among the exhaust ports 2, 3, 4, only the first exhaust port 2 is open whereas the second exhaust port 3 and the third exhaust port 4 are closed (hereinafter, referred to as the “first state of the cooking appliance”), the cooking fumes flowing upward through the exhaust path (A) can be discharged to the outdoors through the first exhaust port 2.

As an example, the first exhaust port 2 can be connected to a duct (not shown) connected to the outdoors. For example, a duct may be installed on the top surface of the main body 10, and the internal space of the duct may be connected to the first exhaust port 2.

The first exhaust port 2 connected to the duct in this way can form a passage connecting the top space section 10i with the outside of the cooking appliance. This first exhaust port 2 may be disposed at the upper side of the top space section 10i, wherein the disposition location may be a position that overlaps with the rear space section 10f in an up and down direction.

That is, the rear fan assembly 100, the rear space section 10f, and the first exhaust port 2 may be disposed at positions where they overlap with one another in an up and down direction. Preferably, the rear fan assembly 100, the rear space section 10f, and the first exhaust port 2 may be disposed in a line along an up and down direction.

Additionally, the exhaust flow path (A) may be disposed between the wind blowing part 100, 200 and the first exhaust port 2 in the rear space section 10f. The entrance of this exhaust flow path (A) may be opened toward the wind blowing part 100, 200, and the exit of the exhaust flow path (A) may be opened toward the top space section 10i. And the first exhaust port 2 may be disposed in a region that overlaps with the exit of the exhaust flow path (A) in an up and down direction.

Accordingly, the air flow caused by the operation of the rear fan assembly 100 can be made in the same straight direction as the disposition direction of the rear fan assembly 100, the rear space section 10f, and the first exhaust port 2.

When air flow is made in a straight line like this, this reduces resistance to air flow, allowing air to flow more smoothly. Accordingly, the air suction and discharge performance of the rear fan assembly 100 can be improved, and thus the cooking fumes removal performance of the cooking appliance can be improved as much as that.

Meanwhile, the cooking appliance of the present embodiment may discharge cooking fumes sucked into the inside of the cooking appliance into the indoors, as shown in FIGS. 14 and 15. At this time, the cooking appliance may be in a state where, among the exhaust ports 2, 3, 4, only the second exhaust port 3 is open whereas the first exhaust port 2 and the third exhaust port 4 are closed (hereinafter referred to as “second state of the cooking appliance”).

In the second state of the cooking appliance, a passage for discharging cooking fumes sucked into the inside of the cooking appliance into the indoors can be provided by the second exhaust port 3. That is, the cooking fumes that has flowed into the rear space section 10f through the intake port 1 can be discharged to the indoors through the second exhaust port 3 after passing through the top space section 10i.

As an example, a filter (not shown) may be disposed at the bottom of the cooking appliance. The filter may be disposed at the intake port 1, so that cooking fumes can be filtered by the filter while passing through the intake port 1.

As another example, the filter may be disposed at the top space section 10i. For example, the filter may be disposed at the inside of the main body 10, wherein the deposition location may be the second exhaust port 3. In this case, the cooking fumes that has flowed from the rear space section 10f to the top space section 10i can pass through the filter, and can be discharged to the indoors through the second exhaust port 3 in a filtered state.

The cooking appliance of this embodiment can discharge, as shown in FIGS. 16 and 17, cooking fumes sucked into the inside of the cooking appliance to the outdoors through the third exhaust port 4.

At this time, the cooking appliance may be in a state where, among the exhaust ports 2, 3, 4, only the third exhaust port 4 is open whereas the first exhaust port 2 and the second exhaust port 3 are closed (hereinafter, referred to as “third state of the cooking appliance”).

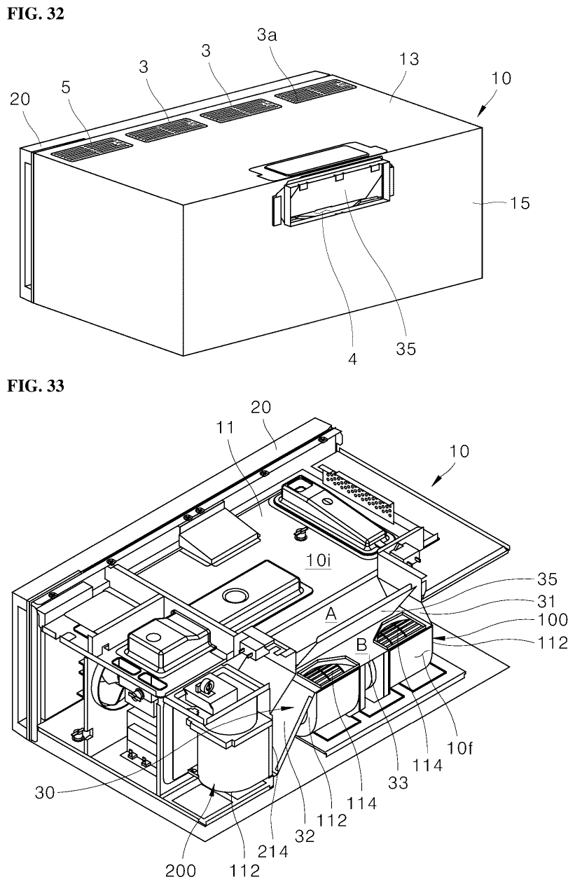

As an example, the third exhaust port 4 may be connected to a pipe or duct (Da; see FIG. 32) embedded in the wall on which the cooking appliance is installed. For example, the pipe or duct (Da) may be combined to the rear plate 15, and the internal space of the pipe or duct (Da) may be connected to the third exhaust port 4.

The third exhaust port 4 connected to the pipe or duct in this way is disposed at the location closest to the wind blowing part 100, 200. Accordingly, when the cooking appliance is in the third state, the distance between the wind blowing part 100, 200 and the exhaust port 2, 3, 4 can be made the shortest length. In addition, since the third exhaust port 4 is disposed on the rear surface of the cooking appliance facing the wall, the third exhaust port 4 and the pipe or duct are not exposed to the outside.

That is, in the third state of the cooking appliance, the cooking appliance can reduce the air flow distance inside the cooking appliance, thereby reducing the flow resistance inside the cooking appliance, while keeping the appearance of the cooking appliance simple and clean.

As described above, the cooking appliance of this embodiment, which employs a structure in which the wind blowing part 100, 200 is disposed in the rear space section 10f, allows the air involved in sucking in cooking fumes and discharging it through the first exhaust port 2 to flow in a straight direction, thereby minimizing flow loss within the cooking appliance, and thereby providing further improved cooking fumes removal performance.

In addition, the cooking appliance of the present embodiment can provide the effect of maintaining a compact size, while allowing the filtering and indoor discharge of cooking fumes to be performed smoothly, by ensuring that the installation space of the filter is effectively secured in the top space section 10i.

Meanwhile, the space section inside the main body 10 may be divided into the side space sections 10e, the rear space section 10f, and the top space section 10i as described above, and the wind blowing part 100, 200 of the present embodiment is not disposed at the side space sections 10e or the top space section 10i, but at the rear space section 10f.

Generally, the lateral length of the side space section 10e where the electrical component chamber is not disposed is set shorter than the front and rear direction length of the rear space section 10f. That is, the side space section 10e can provide just a narrow space compared to the rear space section 10f.

In the rear space section 10f, various devices can be disposed depending on the type of cooking appliance. For example, in the case of a cooking appliance providing a convection function, a convection module may be disposed at the rear space section 10f.

In comparison with this, it is very rare for any other device to be disposed in the side space section 10e that does not form the electrical component chamber 10b, 10c, 10d. Therefore, the lateral width of the above-mentioned side space section 10e does not need to be increased unnecessarily. If the lateral length of the side space section 10e is unnecessarily increased, only the overall size of the cooking appliance increases regardless of whether the performance of the cooking appliance is improved.

Considering this point, it is preferable that the side space section 10e be formed to provide a narrower space compared to the rear space section 10f.

To reduce costs, it is common for cooking appliances with the same cooking chamber volume to employ a main body 10 of the same specifications. For example, a cooking appliance that provides both a high-frequency function and a convection function can be manufactured using a main body 10 of the same specifications as those of a cooking appliance that provides only a high-frequency function.

Accordingly, the main body 10 of the present embodiment may include the rear space section 10f that provides a space suitable for disposing a convection module, and the side space section 10e may be formed in a form that provides only a narrow space compared to the rear space section 10f.

Taking these points into consideration, the wind blowing part 100, 200 of the present embodiment may be disposed at the rear space section 10f which provides more sufficient space than the side space section 10e. By disposing the wind blowing part 100, 200 in the rear space section 10f in this way, not only can the flow loss inside the cooking appliance be reduced as described above, but also a larger and higher-performance fan assembly can be applied to the wind blowing part 100, 200.

That is, the cooking appliance of the present embodiment including the wind blowing part 100, 200 disposed in the rear space section 10f can provide further improved cooking fumes removal performance while suppressing an increase in the size of the cooking appliance by using a main body 10 of standards that is commonly used.

### [Support Member]

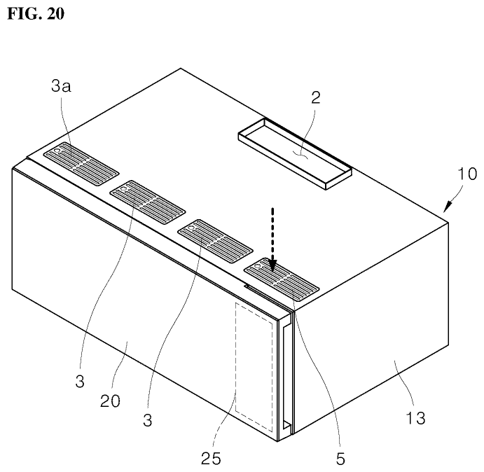

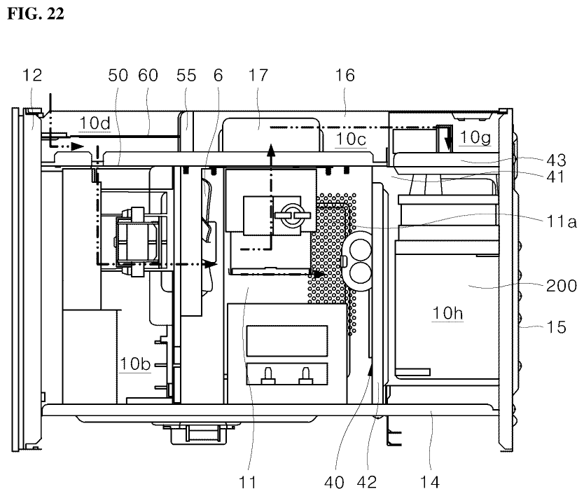

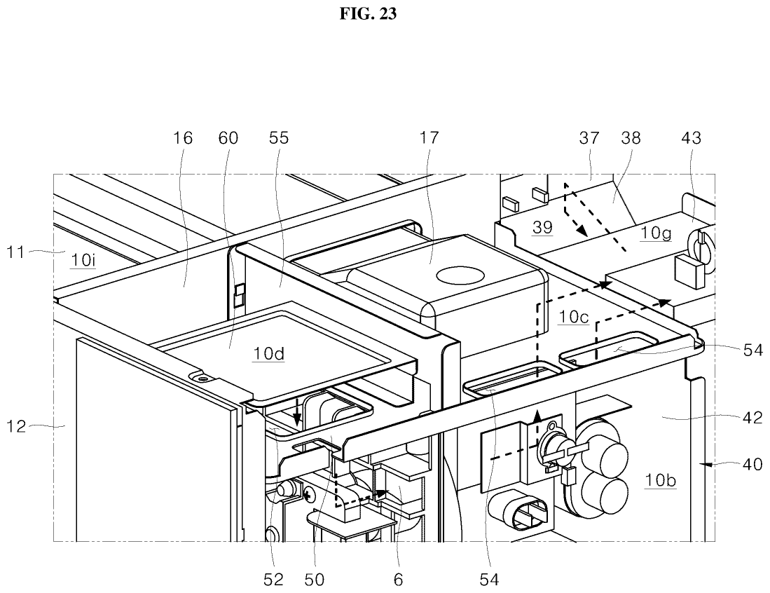

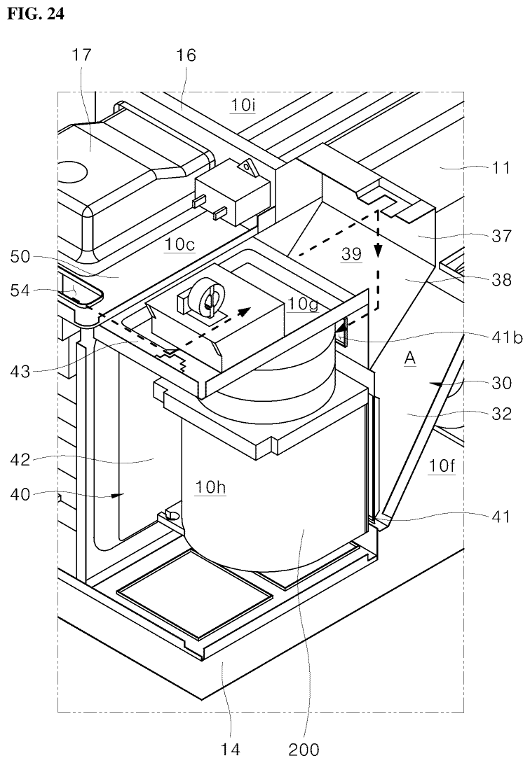

FIG. 18 is an enlarged view of the corner fan assembly and its surroundings, and FIG. 19 is a rear perspective view showing a support member illustrated in FIG. 18 in a separate state. Additionally, FIG. 22 is a rear perspective view showing a portion of a cooking appliance to which another example of a support member is applied, and FIG. 23 is a rear perspective view showing the support member illustrated in FIG. 22 in a separate state.

Referring to FIG. 6, FIGS. 18 and 19, the cooking appliance of the present embodiment may include a support member 40. The support member 40 can support the corner fan assembly 200 so that the flow of air discharged from the second outlet 214 can be guided toward the rear space section 10f.

At least a portion of this support member 40 can form a wall that blocks between the side space section 10e and the rear space section 10f. That is, at least a portion of the support member 40 can form a wall that blocks between the corner fan assembly 200 and the rear fan assembly 100 in the rear space section 10f.

The support member 40 can form a wall that divides the rear space section 10f into two regions along a lateral direction. As an example, the support member 40 may divide a portion of the rear space section 10f adjacent to the side space section 10e as the corner space sections 10g, 10h. Additionally, at least a portion of the support member 40 can form a wall that covers the corner fan assembly 200 from a side. This wall can be formed by the lateral support part 41.

The second outlet 214 may be disposed at a side of the corner fan assembly 200 toward the support member 40, more specifically, the lateral support part 41. And, in the lateral support part 41, the discharge hole 41a may be formed. The discharge hole 41a may be provided so that the second outlet 214 can be exposed in a lateral direction, and may be formed to penetrate through the lateral support part 41 in a lateral direction.

The lateral support part 41 may be combined with the corner fan assembly 200. That is, the corner fan assembly 200 may be combined with the lateral support part 41 in a lateral direction, and may be supported by the support member 40.

The support member 40 may include the front support part 42. The front support member 42 may form the front surface of the support member 40, and may be disposed at the front side of the corner fan assembly 200.

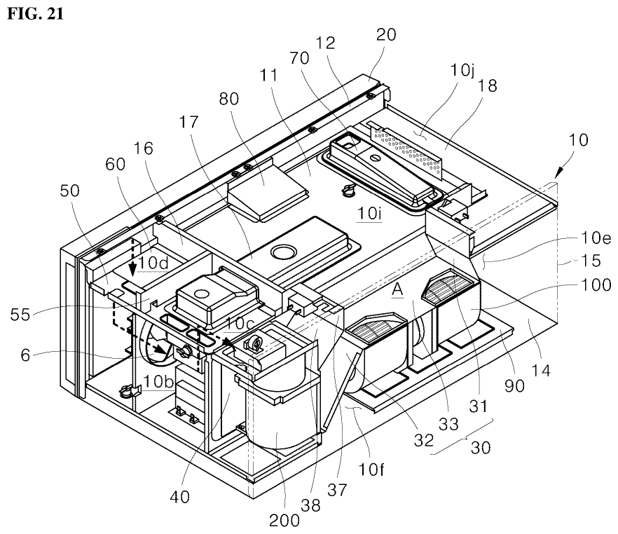

The front support part 42 may form a vertical wall that covers the corner fan assembly 200 from the front. For example, the front support part 42 may form a vertical plane perpendicular to the front and rear direction axis. This front support part 42 may be dispose between the cooling fan 6 (see FIG. 21) to be described later and the corner fan assembly 200, and may form, in the electrical component chamber 10b, 10c, 10d, a wall that blocks between the cooling fan 6 and the corner fan assembly 200.

The front support part 42 may be connected to the lateral support part 41 on a lateral side of the lateral support part 41. As an example, the right end of the front support part 42 may be connected to the front end of the lateral support part 41. For example, the front support part 42 and the lateral support part 41 may be connected to form an “L” shape.

The front support part 42 connected to the lateral support part 41 in this way can support the lateral support part 41 from the front side. This front support part 42 can simultaneously serve as a cover wall that blocks between the cooling fan 6 and the corner fan assembly 200, and as a support wall that supports the lateral support part 41 which supports the corner fan assembly 200.

Additionally, the front support part 42 may include a support surface that forms a vertical plane for being combined with electrical components. For example, electrical components such as a magnetron, a high-voltage transformer, a high-voltage condenser, a noise filter, and the like may be disposed in the electrical component compartments 10b, 10c, 10d, and at least one of the electrical components may be installed on the support surface of the front support part 42. In this embodiment, a high-voltage condenser is, by way of example, installed on the support surface of the front support part 42.

In addition, the support member 40 may further include an upper support part 43. The upper support member 43 may form the top surface of the support member 40, and may be disposed at the upper side of the corner fan assembly 200. As an example, the upper support part 43 may be disposed at the corner space sections 10g, 10h.

The upper support part 43 may be disposed at the upper sides of the lateral support part 41 and the front support part 42, and may be connected with at least one of the lateral support part 41 and the front support part 42 in an up and down direction. In this embodiment, the upper support part 43 is, by way of example, connected with both the lateral support part 41 and the front support part 42.

As an example, the front end of the upper support part 43 may be connected with the upper end of the front support part 42, and the right end of the upper support part 43 may be connected with the upper end of the lateral support part 41. By means of the upper support part 43, the three directional surfaces of the support member 40 can be connected to one another as one piece, and thus the structural stability of the support member 40 can be improved.

Additionally, the upper support member 43 may include a support surface that forms a horizontal plane for being combined with the electrical components. In this embodiment, a noise filter connected to the corner fan assembly is, by way of example, installed on the support surface of the upper support part 43.

The support member 40 including the lateral support part 41, the front support part 42 and the upper support part 43 as described above can provide not only the cover wall between the cooling fan 6 and the corner fan assembly 200, but also a support wall for stable installation of the electrical component and the corner fan assembly 200.

As an example, the support member 40 may be provided in a form in which the lateral support part 41, the front support part 42, and the upper support part 43 are formed integrally. This support member 40 can facilitate the assembly and installation of the support member 40 and spare parts management, and can have excellent structural stability.

### [Structure of Electrical Component Chamber]

FIG. 20 is a view showing the state in which external air flows into the electrical component chamber through a cold air inflow port, and FIGS. 21 to 23 are views showing the flow state of air flowing into the electrical component chamber, and FIG. 24 is a view showing the flow state of air flowing into a lower corner space section through a connecting flow path member from an upper corner space section.

Referring to FIGS. 20 and 21, a cold air inflow port 5 may be provided in the main body 10. The cold air inflow port 5 may be disposed at the top surface of the main body 10 together with the first exhaust port 2 and the second exhaust port 3.

As an example, the cold air inflow port 5 may be formed to penetrate through the top surface of the cabinet 13 in an up and down direction. This cold air inflow port 5 may be disposed on the upper side of the electrical component chamber 10b, 10c, 10d, and may allow the electrical component chamber 10b, 10c, 10d to be open to the outside of the main body 10. External air can flow into the electrical component chamber 10b, 10c, 10d through the cold air inflow port 5.

Referring to FIGS. 21 and 22, the cooking appliance of the present embodiment may include a partition plate 50. The partition plate 50 may be disposed at the side space section 10e, more specifically, at the electrical component chamber 10b, 10c, 10d.

As an example, the partition plate 50 may form a horizontal plane perpendicular to an up and down directional axis. This partition plate 50 can partition the side space section 10e into upper and lower parts, that is, into the lower electrical component chamber 10b and the upper electrical component chamber 10c. For example, the electrical component chamber 10b, 10c, 10d may be divided into the lower electrical component chamber 10b in the lower side of the partition plate 50 and the upper electrical component chamber 10c in the upper side of the partition plate 50.

As an example, within the electrical component chamber 10b, 10c, 10d, the lower electrical component chamber 10b may occupy a much greater space than the upper electrical component chamber 10c. For example, the vertical length of the lower electrical component chamber 10b may be set to be much greater than the vertical length of the upper electrical component chamber 10c. Most of the electrical components, including a magnetron, a high-voltage transformer, and a high-voltage condenser, may be disposed primarily in the lower electrical compartment 10b.

The cooking appliance of the present embodiment may further include the cooling fan 6. The cooling fan 6 is provided to allow external air to flow into the electrical component chamber 10b, 10c, 10d through the cold air inflow port 5. As an example, the cooling fan 6 may be disposed at the lower electrical component chamber 10b together with most of the electrical components.

The wind blowing part 100, 200 may be disposed at the rear side of the cooling fan 6, and the support member 40, more specifically the front support part 42, may be disposed between the cooling fan 6 and the corner fan assembly 200.

The cooling fan 6 can generate airflow to draw external air into the inside of the main body 10 through the cold air inflow port 5.

When the cooling fan 6 is in operation, the external air can flow into the upper electrical component chamber 10c through the cold air inflow port 5. Air that has flowed into the upper electrical component chamber 10c can pass through the partition plate 50 and flow into the lower electrical component chamber 10b.

For this purpose, passage holes 52, 54 may be provided in the partition plate 50. The passage holes 52, 54 may form, in the partition plate 50, a passage for connecting between the upper electrical component chamber 10c and the lower electrical component chamber 10b. As an example, the passage holes 52, 54 may be formed to penetrate through the partition plate 50 in an up and down direction.

Air that has flowed into the upper electrical component chamber 10c through the cold air inflow port 5 can flow into the lower electrical component chamber 10b through the passage holes 52, 54. The air that has flowed into the electrical component chamber 10b, 10c, 10d can cool the electrical components disposed in the lower electrical component chamber 10b.

Additionally, some of the air that has flowed into the lower electrical component chamber 10b may flow into the cooking chamber 10a (see FIG. 2). For this purpose, a side hole 11a may be provided in the cavity 11. The side hole 11a can form a passage connecting between at least one of the lower electrical component chamber 10b and the upper electrical component chamber 10c with the cooking chamber 10a.

In this embodiment, the side hole 11a is, by way of example, disposed at the lower electrical component chamber 10b. As an example, the side hole 11a may be formed to penetrate through the cavity 11 in a lateral direction, and may form, in the cavity 11, a passage connecting between the lower electrical component chamber 10b and the cooking chamber 10a. This side hole 11a may be disposed at the front side of the support member 40.

The cooking appliance of the present embodiment may further include a blocking plate 55. The blocking plate 55 may divide the upper electrical component chamber 10c into front and rear regions, so that the front region of the upper electrical component chamber 10c is separated as an intake chamber 10d.

As an example, the blocking plate 55 may form a vertical wall surface perpendicular to a front and rear direction axis. This blocking plate 55 may be disposed at the upper side of the partition plate 50, and may be combined to the top surface of the partition plate 50.

By means of the blocking plate 55 provided in this manner, the region between the front plate 12 and the blocking plate 55 in the upper electrical component chamber 10c can be divided as the intake chamber 10d.

A plurality of passage holes 52, 54 may be provided in the partition plate 50. As an example, a first passage hole 52 and a second passage hole 54 may be provided in the partition plate 50. The first passage hole 52 and the second passage hole 54 may be disposed spaced apart in a front and rear direction with the blocking plate 55 interposed therebetween.

The first passage hole 52 may form a passage connecting between the intake chamber 10d and the lower electrical component chamber 10b. This first passage hole 52 may be disposed at the front side of the blocking plate 55 and the cooling fan 6, and may be formed to penetrate through the partition plate 50 in an up and down direction.

The second passage hole 54 may form a passage connecting between the upper electrical component chamber 10c and the lower electrical component chamber 10b at the rear side of the intake chamber 10d. This second passage hole 54 may be disposed at the rear side of the blocking plate 55 and the cooling fan 6, and may be formed to penetrate through the partition plate 50 in an up and down direction.

According to this embodiment, the upper support part 43 may be disposed at the rear side of the partition plate 50. The upper support part 43 may be disposed at the corner space section 10g, 10h, and may divide the corner space section 10g, 10h into upper and lower regions. By means of the upper support part 43, the corner space section 10g, 10h may be divided into the upper corner space section 10g and the lower corner space section 10h.

The lower corner space section 10h may be disposed at the lower side of the upper support part 43. The upper boundary surface of the lower corner space section 10h may be defined by the upper support part 43, the front boundary surface of the lower corner space section 10h may be defined by the front support part 42, and the right boundary surface of the lower corner space section 10h may be defined by the lateral support part 41. The corner fan assembly 200 may be disposed at the lower corner space section 10h.

The upper corner space section 10g may be disposed at the upper side of the upper support part 43. The upper corner space section 10g may be disposed at the rear side of the rear side of the upper electrical component chamber 10c, and may be connected to the upper electrical component chamber 10c at the rear side of the upper electrical component chamber 10c.

At least one of the electrical components disposed in the upper electrical component chamber 10c may be disposed at the upper support part 43. As an example, a noise filter connected to the corner fan assembly 200 may be disposed at the upper corner space section 10g, and this noise filter may be installed on the top surface of the upper support part 43.

Air that has flowed into the lower electrical component chamber 10b by the cooling fan 6 can flow into the upper electrical component chamber 10c through the second passage hole 54. The air that has flowed into the upper electrical component chamber 10c in this way can cool the electrical components installed in the upper support part 43 while passing through the upper corner space section 10g.

Meanwhile, the upper electrical component chamber 10c and the lower electrical component chamber 10b may be connected by the connecting flow path member 39. The connecting flow path member 39 can form a passage through which air that has flowed into the lower electrical component chamber 10b by the cooling fan 6 flows toward the wind blowing part 100, 200 through the upper electrical component chamber 10c. For example, the connecting flow path member 39 can form a passage through which air that has flowed into the electrical component chamber 10b, 10c, 10d flows into the corner fan assembly 200 through the upper corner space section 10g.

Additionally, a through hole 41b may be provided in the lateral support part 41. The through hole 41b is provided so that the space surrounded by the lateral support part 41 and the front support part 42, i.e. the lower corner space section 10h, can be opened to a side.

The connecting flow path member 39 can form a passage connecting between the through hole 41b and the upper electrical component chamber 10c, more specifically, the through hole 41b with the upper corner space section 10g. This connecting flow path member 39 can be communicated with the upper corner space section 10g and the lower corner space section 10h from the side of the upper corner space section 10g, 10h, respectively. The connecting flow path member 39 can be communicated with the lower corner space section 10h through the through hole 41b.

As described above, the connecting flow path member 39 can be formed by the connecting flow path forming member 37, 38. In the connecting flow path forming member 37, 38, the first partition 37 can form a vertical wall that is disposed spaced apart from the side of the lateral support part 41 by a predetermined interval. And the second partition 38 can be connected to the lateral support part 41 at the lower side of the through hole 41b, and can form a wall connecting the lateral support part 41 with the first partition 37.

Opposite sides of the connecting flow path member 39 can be defined by the lateral support part 41 and the first partition 37. For example, the left side of the connecting flow path member 39 may be defined by the lateral support part 41, and the right side of the connecting flow path member 39 may be defined by the first partition 37. The bottom of the connecting flow path member 39 can be defined by the second partition 38.

Air that has flowed into the upper electrical component chamber 10c can flow into the connecting flow path member 39 through the upper corner space section 10g. Air that has flowed into the connecting flow path member 39 can flow into the lower corner space section 10h through the through hole 41b, and then can be sucked into the corner fan assembly 200.

The suction force of the corner fan assembly 200 can be applied to the lower corner space section 10h. In this way, the suction force acting in the lower corner space section 10h can also affect the connecting flow path member 39 connected with the lower corner space section 10h, and the upper corner space section 10g. That is, the suction force of the corner fan assembly 200 can affect the upper corner space section 10g, and this can act as a force to cause the air flowing into the upper corner space section 10g to flow toward the lower corner space 10h.

Ultimately, the suction force of the corner fan assembly 200 can act as a force to guide the flow of the air, which has flowed from the lower electrical component chamber 10b to the upper electrical component chamber 10c, to the lower corner space section 10h through the connecting flow path member 39.

Hereinafter, the air flow in the electrical component chamber 10b, 10c, 10d will be described.

External air can flow into the inside of the main body 10 through the cold air inflow port 5, as shown in FIG. 20. The air that has passed through the cold air inflow port 5 in this way can flow into the intake chamber 10d, as shown in FIGS. 21 to 23.

The air that has flowed into the intake chamber 10d can flow into the lower electrical component chamber 10b through the partition plate 50 via the first passage hole 52. In the lower electrical component chamber 10b, the air can flow rearward by the cooling fan 6. In this way, the air flowing rearward in the lower electrical component chamber 10b can cool electrical components disposed in the lower electrical component chamber 10b.

Some of the air flowing in the lower electrical component chamber 10b can pass through the cavity 11 via the intake port 1, and flow into the cooking chamber 10a. Another portion of the air flowing in the lower electrical component chamber 10b can flow into the upper electrical component chamber 10c through the partition plate 50 via the second passage hole 54.

In the upper electrical component chamber 10c, the air can flow toward the connecting flow path member 39 under the influence of the suction force of the corner fan assembly 200. For example, the air that has flowed into the upper electrical component chamber 10c can pass through the upper corner space section 10g while cooling the electrical components, and then flow into the connecting flow path member 39 as shown in FIG. 24.

The air that has flowed into the connecting flow path member 39 can pass through the lateral support part 41 via the through hole 41b, can flow into the lower corner space section 10h, and then can be sucked into the corner fan assembly 200. That is, the air that has flowed into the lower corner space section 10h from the connecting flow path member 39 can be combined with air flowing into the inside of the main body 10 through the intake port 1, as shown in FIG. 11, and then can be sucked into the corner fan assembly 200 and then discharged into the exhaust flow path (A).

As illustrated in FIGS. 20 to 24, the flow path formed in the electrical component chamber 10b, 10c, 10d, the corner space section 10g, 10h, and the connecting flow path member 39 allows the force provided by the suction force of the corner fan assembly 200 to be added to the force provided by the cooling fan 6 in the electrical component chamber 10b, 10c, 10d, thereby enabling the air to flow more smoothly within the electrical component chamber 10b, 10c, 10d and contribution to more effective cooling of electrical components disposed at the electrical component chamber 10b, 10c, 10d.

In addition, as described above, the flow path formed in the electrical component chamber 10b, 10c, 10d, the corner space section 10g, 10h, and the connecting flow path member 39 can contribute to increasing the air suction amount of the corner fan assembly 200 by allowing the air that has flowed into the electrical component chamber 10b, 10c, 10d to flow toward the corner fan assembly 200, and ultimately to effectively increasing the discharge air amount of the corner fan assembly 200.

Meanwhile, referring to FIGS. 21 to 27, the cooking appliance of the present embodiment may further include a flow path partition plate 16. The flow path partition plate 16 is provided to divide the space in the upper side of the cavity 11 and the partition plate 50. This flow path partition plate 16 can divide the space in the upper side of the cavity 11 and the partition plate 50 into the upper electrical component chamber 10c and the top space section 10i.

As an example, the flow path partition plate 16 may form a vertical wall perpendicular to a lateral axis. This flow path partition plate 16 can block between the upper electrical component chamber 10c and the top space section 10i to separate these two spaces from each other. For example, the flow path partition plate 16 may define the right boundary surface of the upper electrical component chamber 10c and the left boundary surface of the top space section 10i.

In addition, the cooking appliance of the present embodiment may include a waveguide 17. The waveguide 17 is provided to convey microwaves generated from a magnetron installed in the electrical component chamber 10b, 10c, 10d to the cooking chamber 10a.

The waveguide 17 may be disposed at the upper electrical component chamber 10c and the top space section 10i, and may be installed on the top surface of the partition plate 50 and the cavity 11. That is, a portion of the waveguide 17 may be installed on the top surface of the partition plate 50, and the remaining portion of the waveguide 17 may be installed on the top surface of the cavity 11 by penetrating through the partition plate 16 in a lateral direction.

A space may be formed inside the waveguide 17, and the entrance of the waveguide 17 connected to this space may be connected to the magnetron, and the exit of the waveguide 17 connected to this space may be connected to the cooking chamber 10a. Microwaves introduced into the inside of the waveguide 17 through the entrance of the waveguide 17 can be introduced into the cooking chamber 10a through the exit of the waveguide 17.

The exit of the waveguide 17 can be connected to the cooking chamber 10a at the top surface of the cavity 11. Accordingly, microwaves conveyed from the magnetron through the waveguide 17 can be introduced into the cooking chamber 10a from the upper side of the cooking chamber 10a through the top surface of the cavity 11. As an example, the exit of the waveguide 17 may be disposed at the upper side of the cavity 11, wherein the deposition location may be the lateral center of the cavity 11 appropriately.

If the vertical length of the cooking appliance becomes less, the vertical length of the cooking chamber 10a is also likely to become less. Even if the wind blowing part 100, 200 is disposed at the rear space section 10f instead of the top space section 10i, and thus the vertical length of the top space section 10i can be reduced, the reduction in the length of the top space section 10i cannot but be smaller than the reduction in the length of the entire cooking appliance, so it is difficult to avoid a reduction in the length of the cooking chamber 10a caused by the reduction in the length of the cooking appliance.

In this case, the shape of the cooking chamber 10a has a flat shape in the horizontal direction compared to the cooking chamber of a conventional cooking appliance. In the case where microwaves are introduced into the cooking chamber 10a through the side of the cavity 11 in the cooking appliance having the cooking chamber 10a of this shape, it is difficult for the microwaves to be evenly supplied to the entire cooking chamber 10a.

Considering this point, in this embodiment, the waveguide 17 may be installed on the top surface of the cavity 11, and microwaves may be introduced into the cooking chamber 10a through the top surface of the cavity 11. That is, in the cooking appliance of this embodiment, microwaves may be supplied through the upper side of the cooking chamber 10a, and thus, microwaves can be supplied evenly throughout the entire cooking chamber 10a.

### [Structure of Top Space Section]

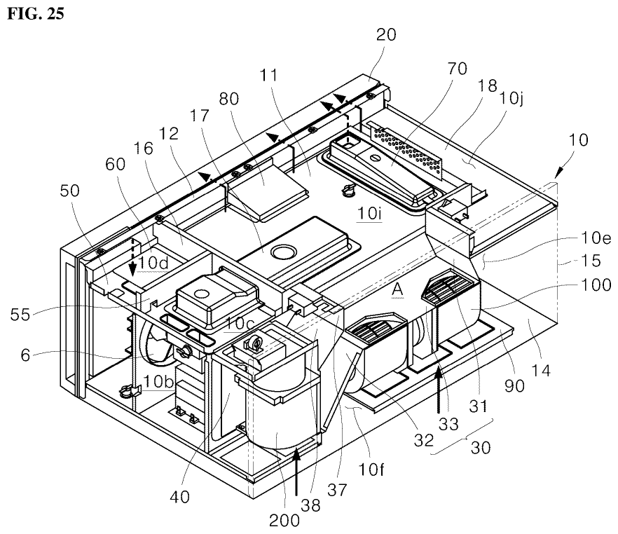

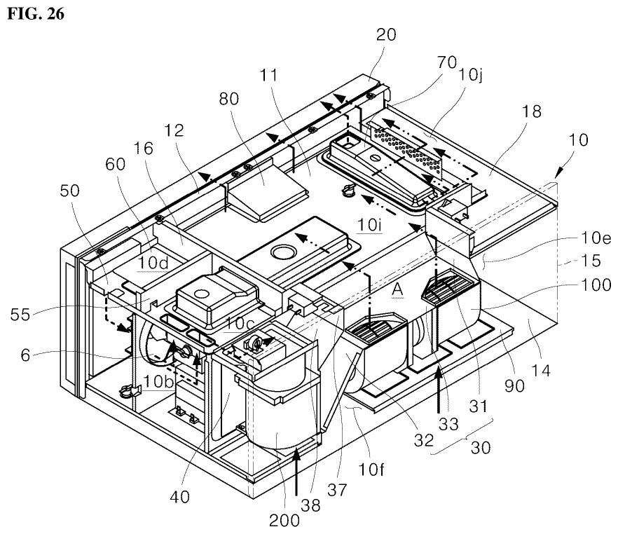

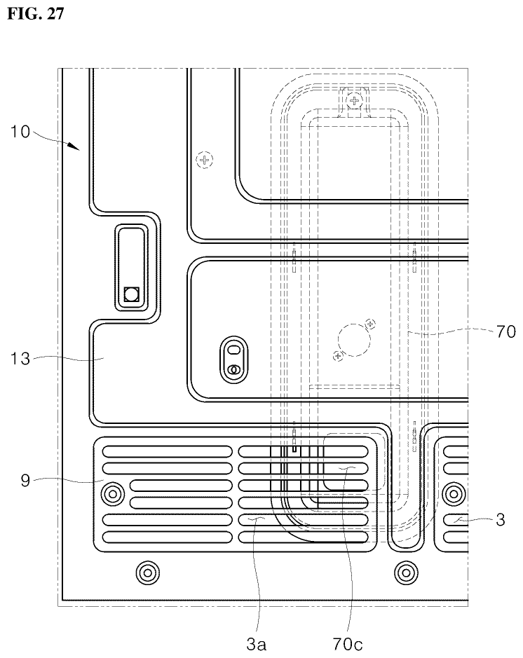

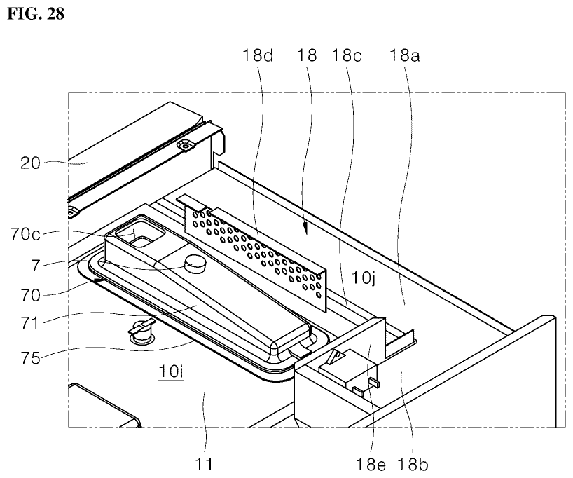

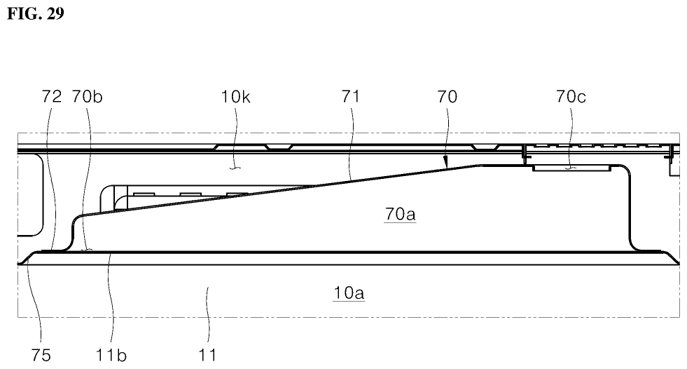

FIG. 25 is a rear perspective view showing the intake and exhaust states of a cooking appliance according to the first embodiment of the present invention, and FIG. 26 is a rear perspective view showing the air flow state inside the cooking appliance illustrated in FIG. 25. Additionally, FIG. 27 is a plan view showing an enlarged view of a region around a common exhaust port shown in FIG. 25, and FIG. 28 is an enlarged view showing the exhaust duct and its surroundings, and FIG. 29 is a cross-sectional side view showing the side shape of an exhaust duct.

Referring to FIG. 12 and FIGS. 25 to 29, a circulation air discharge port 11b may be provided inside the main body 10. The circulation air discharge port 11b may form, on the top surface of the cavity 11, a passage connecting between the cooking chamber 10a and the top space section 10i. As an example, the circulation air discharge port 11b may be formed to penetrate through the top surface of the cavity 11 in an up and down direction.

According to this embodiment, a plurality of second exhaust ports 3 may be disposed at the top of the main body 10. At least one of the plurality of second exhaust ports 3 may be provided as a common exhaust port 3a. The common exhaust port 3a is provided so that air flowing into the top space section 10i by the wind blowing part 100, 200 and air flowing into the top space section 10i through the circulation air discharge port 11b can be discharged together.

As an example, the circulation air discharge port 11b may be disposed at a position offset to the right from the lateral center of the cavity 11. For example, the circulating air discharge port 11b may be disposed at a position overlapping with at least a portion of the common exhaust port 3a in a front and rear direction.

According to this embodiment, a plurality of second exhaust ports 3 and cold air inflow port 5 may be arranged in a lateral direction. As an example, at least one of the plurality of second exhaust ports 3, which is disposed furthest from the cold air inflow port 5 may be provided as the common exhaust port 3a. For example, the cold air inflow port 5 may be disposed at the left side of the second exhaust port 3, and one of the plurality of second exhaust ports 3, which is disposed at the rightmost side may be provided as the common exhaust port 3a.

As another example, at least one of the plurality of second exhaust ports 3 arranged in a lateral direction, which is disposed at the farthest position from the electrical component chamber 10b, 10c, 10d may be provided as the common exhaust port 3a.

As another example, at least one of the plurality of second exhaust ports 3 arranged in a lateral direction, which is disposed at the closest position to the expansion plate 18 may be provided as the common exhaust port 3a. At this time, at least a portion of the common exhaust port 3a may be disposed to overlap with the expansion plate 18 in an up and down direction.

Additionally, an exhaust duct 70 may be disposed at the top space section 10i. The exhaust duct 70 is provided so as to guide, toward the common exhaust port 3a, the flow of air discharged from the cooking chamber 10a to the circulation air discharge port 11b.

In this embodiment, the circulation air discharge port 11b may be disposed at a position offset toward the rear from the center in the front and rear direction of the cavity 11. For example, the circulation air discharge port 11b may be disposed at the top surface of the cavity 11, so that it may be adjacent to the rear right corner of the cavity 11.

The exhaust duct 70 is provided so as to guide, toward the common exhaust port 3a disposed at a location adjacent to the front of the main body 10, the flow of air discharged to the circulation air discharge port 11b disposed at the aforementioned location.

Additionally, the cooking appliance of the present embodiment may include an expansion plate 18. The expansion plate 18 may divide the side space section 10e so that a portion of the side space section 10e is separated as an expansion top space section 10j. By means of the expansion plate 18, the portion of the side space section 10e, which is above the expansion plate 18 may be divided as the expansion top space section 10j.

### [Expansion Plate]

Referring to FIGS. 12, 25 and 28, at least a portion of the expansion plate 18 may be disposed at the side space section 10e. In this embodiment, the expansion plate 18 is, by way of example, disposed at the side space section 10e among the pair of side space sections 10e disposed inside the cooking appliance, which is not the electrical component chamber 10b, 10c, 10d.

As an example, the expansion plate 18 may form a horizontal plane perpendicular to an up and down direction axis. For example, the expansion plate 18 may form a plane parallel to the top surface of the cavity 11.

Preferably, the top surface of the expansion plate 18 and the top surface of the cavity 11 may form the same plane. The top surface of the cavity 11 can define the bottom surface of the top space 10i, and the top surface of the expansion plate 18 can define the bottom surface of the expanded top space section 10j. Accordingly, the bottom surface of the top space section 10i and the bottom surface of the expansion top space section 10j can be disposed at the same plane.

The expansion top space section 10j provided as described above may be communicated with the top space section 10i at the upper side of the side space section 10e. That is, the expansion top space section 10j can be disposed at the upper side of the side space section 10e and the lateral side of the top space section 10i, and can be connected with the top space section 10i in a lateral direction.

According to the present embodiment, the top space section 10i and the expansion top space section 10j can be connected to each other as one piece on the upper side of the cavity 11, and accordingly, an exhaust space 10i, 10j can be formed on the upper side of the cavity 11 and the side space section 10e. In this embodiment, the exhaust space 10i, 10j can be defined as a space in which the top space section 10i and the expansion top space section 10j are connected with each other as one piece on the upper side of the cavity 11 and the expansion plate 18 connected with each other as one piece.

The exhaust space 10i, 10j formed on the upper side of the cavity 11 and the expansion plate 18 in this way can be communicated with the exhaust ports 2, 3, 4 disposed at the top surface of the main body 10. The exhaust ports 2, 3, 4 can open the space where the top space section 10i and the expansion top space section 10j are connected with each other, that is, the exhaust space 10i, 10j, to the outside of the main body 10.

The side space sections 10e and the rear space section 10f may be communicated with the bottom space section. The side space sections 10e and the rear space section 10f may be connected to the bottom space section in an up and down direction, and may be connected to it in a lateral direction. The intake port 1 can be communicated with the bottom space section, and the side space sections 10e and the rear space section 10f can be communicated with the intake port 1 through the bottom space section.

A portion of the expansion plate 18 may be disposed at the rear space section 10f. Accordingly, a portion of the expansion plate 18 (18a; hereinafter, referred to as “side partition of the expansion plate”) may be disposed at the side space section 10e, and another part of the expansion plate 18 (18b; hereinafter, referred to as “rear partition of the expansion plate”) may be disposed at the rear space section 10f.

As described above, the side partition 18 of the expansion plate 18 can divide the side space section 10e so that a portion of the side space section 10e is separated as the expansion top space section 10j. And the rear partition 18b of the expansion plate 18 can divide a portion of the rear space section 10f so that the portion of the rear space section 10f is separated as the expansion top space section 10j.

That is, the expansion plate 18 can divide a portion of the rear space section 10f and the side space section 10e so that the portion of the rear space section 10f and the side space section 10e are separated as the expansion top space section 10j.

In the expansion plate 18, there may be provided a first combining part 18c. The first combining part 18c may be provided for combining the expansion plate 18 with the cavity 11. As an example, the first combining part 18c may be formed to protrude horizontally from at least one of the side partition 18 and the rear partition 18b. This first combining part 18c may abut against the top surface of the cavity 11 in an up and down direction, and may be combined with the cavity 11.

The combination between the first combining part 18c and the cavity 11 may be made by a joining method such as welding, or by a fastening method such as a screw.

In this embodiment, the first combining part 18c is, by way of example, formed to protrude from the side partition 18 in a lateral direction. As another example, the first combining part 18c may be formed to protrude forward from the rear portion 18b. As another example, the first combining part 18c may protrude vertically from at least one of the side partition 18 and the rear partition 18b to be connected to the side surface of the cavity 11.

Additionally, the expansion plate 18 may include at least one of the second combining part 18d and the third combining part 18e. The second combining part 18d and the third combining part 18e may be provided for combining the expansion plate 18 with the cabinet 13.

The second combining part 18d may be provided in a protruding form from the side partition 18 or the first combining part 18c. In this embodiment, the first combining part 18c protrudes, by way of example, from the side partition 18 horizontally, and the second combining part 18d protrudes, by way of example, from the first combining part 18c vertically.

As an example, the second combining part 18d may form a vertical wall perpendicular to a lateral axis. At the upper end of the second combining part 18d, a plane parallel to the top surface of the cabinet 13 may be formed.

The third combining part 18e may be provided in a protruding form from the rear partition 18b. As an example, the third combining part 18e may form a vertical wall perpendicular to a front and rear direction axis. At the upper end of the third combining part 18e, a plane parallel to the top surface of the cabinet 13 may be formed.

The vertical lengths of the second combining part 18d and the third combining part 18e may be each set to a length corresponding to the distance between the expansion plate 18 and the cabinet 13. The second combining part 18d and the third combining part 18e formed in this manner can be combined with the cabinet 13 at the lower side of the cabinet 13.

By the combination between the second combining part 18d and the cabinet 13, and the combination between the third combining part 18e and the cabinet 13, the expansion plate 18 can support the cabinet 13 so that the top surface of the cabinet 13 does not sag downward. In addition, the expansion plate 18 can be stably fixed inside the cooking appliance by being combined with multiple structures at multiple locations using the first combining part 18c, the second combining part 18d, and the third combining part 18e.

As an example, the second combining part 18d may be disposed between the top space section 10i and the expansion top space section 10j. That is, the second combining part 18d may be disposed at the exhaust space 10i, 10j in a form of a vertical wall that blocks partially between the top space section 10i and the expansion top space section 10j in a lateral direction.

This second combining part 18d may be provided with a plurality of ventilation holes. Each ventilation hole may be formed to penetrate through the second combining part 18d in a lateral direction, and the ventilation holes may be disposed at the most region of the second combining part 18d.

The second combining part 18d having a plurality of ventilation holes in this way can provide a structure for combining the expansion plate 18 with the cabinet 13, while minimizing interference with the second combining part 18d of the flow of air within the exhaust space 10i, 10j.

In this embodiment, the third combining part 18e is, by way of example, disposed in a region where the rear space section 10f and the top space section 10i overlap with each other or in another region very close to the region. This third combining part 18e may be disposed at a position adjacent to the rear fan assembly 100 disposed at the rear space section 10f.

To the third combining part 18e disposed in this manner, an electrical component related to the rear fan assembly 100, such as a capacitor connected to the rear fan assembly 100, may be coupled. That is, the third combining part 18e can simultaneously perform the role of providing a structure for combining the expansion plate 18 with the cabinet 13, and the role of providing a structure for installing electrical components related to the rear fan assembly 100.

### [Types of Exhaust Through Exhaust Space]

Referring to FIG. 14 and FIGS. 26 to 28, the top space section 10i may be formed at the upper side of the cavity 11. Additionally, the expansion top space section 10j may be formed at the upper side of the side space section 10e which is not the electrical component chamber 10b, 10c, 10d.

As described above, the top space section 10i and the expansion top space section 10j may be connected to each other as one at the upper side of the cavity 11, and accordingly, the exhaust space 10i, 10j may be formed at the upper side of the cavity 11 and the side space section 10e.

The expansion top space section 10j may be formed by the expanded plate 18 that divides the side space section 10e into upper and lower regions. In this embodiment, the expansion plate 18 can serve to expand the exhaust space 10i, 10j in a lateral direction by making the exhaust space 10i, 10j a space that includes not only the top space section 10i but also the expansion top space section 10j. In addition, the expansion plate 18 can serve to separate the side space section 10e from the exhaust space 10i, 10j.

As the exhaust space 10i, 10j is expanded as a space that includes both the top space section 10i and the expansion top space section 10j, the size of the flow path required for the flow of air discharged to the second exhaust port 3 through the exhaust space 10i, 10j can be expanded. In particular, the size of the exhaust space 10i, 10j can be expanded in a lateral direction by the size of the expansion top space section 10j.

That is, the expansion plate 18 of the present embodiment can provide an effect of allowing the size of the exhaust space 10i, 10j to be expanded by dividing the side space section 10e to form the expansion top space section 10j that can be connected with the top space section 10i.

As described above, in the cooking appliance of the present embodiment, the wind blowing part 100, 200 is not disposed at the top space section 10i but at the rear space section 10f. Accordingly, there is no need to secure the space required for installing the wind blowing part 100, 200 in the top space section 10i, so the height of the top space section 10i can be lowered compared to the case where the wind blowing part is installed in the top space section.

In the cooking appliance of the present embodiment, one of the methods for reducing the size of the entire cooking appliance while minimizing the reduction in the volume of the cooking chamber, that is, reducing the height of the entire cooking appliance while minimizing the reduction in the height of the cooking chamber, is to reduce the height of the top space section 10i.

Considering this point, the height of the top space section 10i of the cooking appliance of the present embodiment is set less than that of the top space section of a conventional cooking appliance. That is, in the cooking appliance of the present embodiment, the height of the top space section 10i is set to a height which is so less that the rear fan assembly 100 or the corner fan assembly 200 cannot be installed thereat.

As the height of the top space section 10i decreases in this way, the volume of the top space section 10i also inevitably decreases. Since the top space section 10i is a space related to exhaust, the decrease in the volume of the top space section 10i inevitably leads to decrease in the size of the flow path required for the flow of air discharged to the second exhaust port 3 accordingly.

If the size of the flow path required for the flow of air discharged to the second exhaust port 3 is reduced, the exhaust performance of the cooking appliance cannot avoid being deteriorated. In addition, if the exhaust performance of the cooking appliance deteriorates, the intake performance of the cooking appliance would also inevitably deteriorate, which would, in turn, result in deterioration of the cooking fumes removal performance of the cooking appliance.

Considering this point, in this embodiment, the expansion top space section 10j is separated from the side space section 10e by the expansion plate 18 that divides the side space section 10e into upper and lower regions, and this expansion top space section 10j is connected with the top space section 10i, thereby allowing the size of the entire exhaust space 10i, 10j including the top space section 10i to be expanded. Accordingly, the size of the flow path required for the flow of air discharged to the second exhaust port 3 through the exhaust space 10i, 10j can be effectively expanded.

If the size of the flow path required for the flow of air discharged to the second exhaust port 3 through the exhaust space 10i, 10j in this way is expanded, the exhaust performance of the cooking appliance can be improved accordingly, and ultimately the cooking fumes removal performance of the cooking appliance can be improved.

Meanwhile, structures such as an exhaust duct 70 and a lamp cover 80 are disposed at the exhaust space 10i, 10j. Each of them has a shape that protrudes from the top surface of the cavity 11 into the exhaust space 10i, 10j to perform its respective function.

For example, the exhaust duct 70 is formed in a shape that protrudes from the top surface of the cavity 11 to have a flow path formed therein for the flow of air discharged from the cooking chamber. And the lamp cover 80 is formed in a shape that protrudes from the top surface of the cavity 11 to cover a lamp from the upper side and to be combined to the front plate 12.

Each of the exhaust duct 70 and lamp cover 80 may be formed into a shape including a slope. That is, each of the exhaust duct 70 and the lamp cover 80 is inevitably formed in a shape that protrudes from the top surface of the cavity 11 in order to perform its respective function, but each of them can be formed in a shape which is capable of reducing the flow resistance generated by the exhaust duct 70 or the lamp cover 80 in the exhaust space 10i, 10j.

That is, in the present embodiment, by expanding the size of the exhaust space 10i, 10j with the expansion top space section 10j, so that the size of the flow path required for the flow of the air discharged to the second exhaust port 3 through the exhaust space 10i, 10j is expanded, and by rendering the exhaust duct 70 and the lamp cover 80 disposed at the exhaust space 10i, 10j to have a shape that can reduce the flow resistance caused by them, the air discharged to the second exhaust port 3 through the exhaust space 10i, 10j can flow smoothly.

Accordingly, the cooking appliance of the present embodiment can provide cooking fumes removal performance equivalent to or superior to that of conventional cooking appliances with similar potential cooking capacity, while at the same time providing a smaller overall size.

In addition, the above expansion plate 18 can act as a barrier wall blocking between the side space section 10e and the exhaust space 10i, 10j. Accordingly, the side space section 10e can be separated from the exhaust space 10i, 10j by the expansion plate 18.

That is, the expansion plate 18 forms, on the upper side of the expansion plate 18, a space in which the top space section 10i and the expansion top space section 10j are connected to each other, but the expansion plate 18 blocks the passage between the side space section 10e and the exhaust space 10i, 10j.

According to the present embodiment, the side space section 10e is connected with the bottom space section formed between the intake port 1 and the cavity 11. Accordingly, the side space section 10e may be termed as a space connected with the intake port 1. And the exhaust space 10i, 10j may be termed as a space connected with the second exhaust port 3. In other words, the side space section 10e may be termed as a space associated with intake, and the exhaust space 10i, 10j may be termed as a space associated with exhaust.

The expansion plate 18 can separate the space associated with exhaust from the space associated with intake by separating the exhaust space 10i, 10j from the side space section 10e. Accordingly, the space associated with the exhaust can be expanded by the expansion top space section 10j, and the space associated with the intake can be expanded by as much as the space occupied by the side space section 10e.

That is, since the exhaust space 10i, 10j is separated from the side space section 10e by the expansion plate 18, the space associated with exhaust and the space associated with intake can be respectively secured to a sufficient size required for intake or exhaust.

In addition, since the exhaust space 10i, 10j and the side space section 10e are separated from each other by the expansion plate 18, a phenomenon in which air in the exhaust space 10i, 10j is sucked back into the wind blowing part 100, 200, i.e. the occurrence of a backflow phenomenon, can be effectively suppressed, so that the exhaust performance of the cooking appliance can be effectively improved.

Meanwhile, in the cooking appliance of the present embodiment, a plurality of second exhaust ports 3 may be disposed. Each second exhaust port 3 may be disposed at the top surface of the main body 10, wherein it may be disposed adjacent to the front surface of the main body 10, and may be communicated with the exhaust space 10i, 10j.

In the main body 10, the cold air inflow port 5 and a plurality of second exhaust ports 3 may be arranged in a lateral direction. Additionally, any one of the plurality of second exhaust ports 3 may be provided as the common exhaust port 3a.

In this embodiment, the cold air inflow port 5 is, by way of example, disposed at the left side of the second exhaust ports 3, and one of the plurality of second exhaust ports 3, which is disposed at the rightmost side is, by way of example, provided as the common exhaust port 3a.

At least a portion of the common exhaust port 3a may be disposed to overlap with at least a portion of the duct discharge port 70c provided in the exhaust duct 70. That is, when viewed from above, at least a portion of the duct discharge port 70c may be exposed to the upper side through the common exhaust port 3a. Accordingly, the air discharged through the duct discharge port 70c can be effectively discharged through the common exhaust port 3a.

Some of the air that has flowed into the electrical component chamber 10b, 10c, 10d through the cold air inflow port 5 may flow into the cooking chamber 10a. The air that has flowed into the cooking chamber 10a can be discharged to the exhaust duct 70 together with the steam, gas, etc. generated in the cooking chamber 10a during the cooking process of the cooking appliance.

The air that has flowed into the exhaust duct 70 can be discharged through the duct discharge port 70c, and the air discharged from the exhaust duct 70 can be discharged to the outside of the cooking appliance through the common exhaust port 3a. In other words, the common exhaust port 3a can become an exit used to discharge, to the outside the cooking appliance, the air that has been discharged from the cooking chamber.

In this embodiment, at least a portion of the common exhaust port 3a is, by way of example, disposed at the left side of the expansion top space section 10j. This common exhaust port 3a may be disposed at the upper side of the boundary between the top space section 10i and the expansion top space section 10j. That is, when viewed from above, the boundary between the top space section 10i and the expansion top space section 10j may be exposed to the upper side of the cooking appliance through the common exhaust port 3a.

As an example, the approximate left half of the common exhaust port 3a may be disposed at the upper side of the top space section 10i. And the remaining half of the common exhaust port 3a may be disposed at the upper side of the expansion top space section 10j.

This common exhaust port 3a can discharge the air that has discharged from the exhaust duct 70 and the air that has flowed into the exhaust space 10i, 10j from the wind blowing part 100, 200, together. That is, steam and gas discharged from the cooking chamber and cooking fumes sucked in through the wind blowing part 100, 200 can be discharged together through the common exhaust port 3a.

According to the present embodiment, the exhaust space 10i, 10j may include the top space section 10i and the expansion top space section 10j, and the air sucked through the wind blowing part 100, 200 can flow to not only the top space section 10i but also the expansion top space section 10j. In particular, the air flowing from the wind blowing part 100, 200 to the expansion top space section 10j can be discharged to the outside of the cooking appliance through the common exhaust port 3a.

Of course, the air flowing from the wind blowing part 100, 200 to the expansion top space section 10j is not necessarily discharged to the outside of the cooking appliance only through the common exhaust port 3a, and may also be discharged to the outside of the cooking appliance through the second exhaust port 3 that is not the common exhaust port 3a.

If the expansion plate 18 is not provided inside the main body 10 and, accordingly, the expansion top space section 10j is not formed inside the main body 10, then the region occupied by the exhaust space 10i, 10j would be inevitably reduced to only the top space section 10i.

In this case, most of the lower region of the common exhaust port 3a would be occupied by the exhaust duct 70, and it would become difficult to form a passage connecting between the common exhaust port 3a and the exhaust space 10i, 10j.

Additionally, if an expansion plate 18 is not provided inside the main body 10, the common exhaust port 3a would be directly connected with the side space section 10e. In this case, the suction force of the rear fan assembly 100 acting on the side space section 10e would affect the periphery of the common exhaust port 3a.

In this case, it would become considerably difficult for the air flowing from the wind blowing part 100, 200 to the exhaust space 10i, 10j to be discharged to the outside of the cooking appliance through the common exhaust port 3a. As a result, only steam and gas discharged from the cooking chamber would be mainly discharged through the common exhaust port 3a, and the cooking fumes sucked in by the wind blowing part 100, 200 would be hardly discharged.

In contrast, in the cooking appliance of the present embodiment, the side space section 10e and the expansion top space section 10j are separated from each other by the expansion plate 18, and the region occupied by the exhaust space 10i, 10j can be expanded not only to the top space section 10i but also to the expansion top space section 10j which is a region disposed at the lower side of the common exhaust port 3a.

Accordingly, the cooking appliance of the present embodiment can discharge the steam and gas discharged from the cooking chamber and the cooking fumes sucked in through the wind blowing part 100, 200 together through the common exhaust port 3a.

### [Example of Third State of Cooking Appliance]

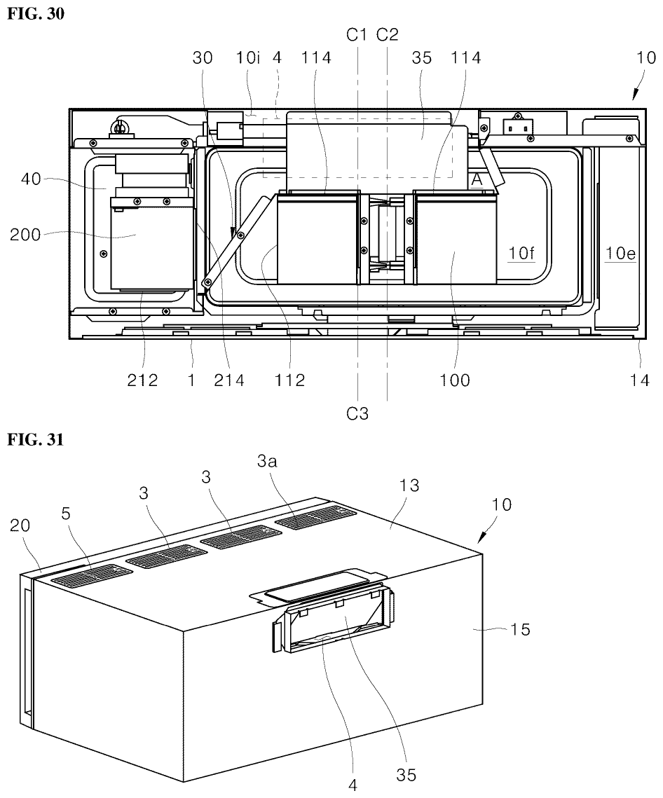

FIG. 30 is a rear view showing the location of a rear fan assembly relative to the location of a third exhaust port.

Referring to FIGS. 16 and 30, the third exhaust port 4 may be disposed at the rear surface of the cooking appliance, and may be formed to penetrate through the rear plate 15 in a front and rear direction. This third exhaust port 4 may be disposed at the rear side and upper side of the rear fan assembly 100. Additionally, the third exhaust port 4 may be disposed at the rear side of the rear space section 10f and the top space section 10i.

At least a portion of the third exhaust port 4 may be disposed at the lateral center (C1) of the main body 10. As an example, the lateral center (C3) of the third exhaust port 4 may be disposed at the lateral center of the rear plate 15, thereby allowing the third exhaust port 4 to be disposed at the lateral center (C1) of the main body 10.

At the front side of the third exhaust port 4, the rear fan assembly 100 is disposed. According to the present embodiment, the rear fan assembly 100 may be provided in a form in which a pair of fan modules are connected to opposite sides of the fan motor. That is, the rear fan assembly 100 may include a pair of impellers 120 arranged in a lateral direction, and the fan motor may be disposed at the lateral center (C2) of the rear fan assembly 100.

The rear fan assembly 100 provided in this manner can suck in air through a pair of first intake ports 112 disposed respectively at the laterally opposite sides of the rear fan assembly 100, and can discharge air through a pair of first discharge ports 114 disposed at the upper side of the rear fan assembly 100.

In the rear space section 10f, the rear fan assembly 100 and the corner fan assembly 200 may be arranged in a lateral direction. The corner fan assembly 200 may be disposed at one lateral side, i.e., the right side, of the rear fan assembly 100, and the rear fan assembly 100 may be disposed to be spaced apart from the corner fan assembly 200 by a predetermined distance in a lateral direction.

According to the present embodiment, the rear fan assembly 100 may be disposed at a position that is offset to the other lateral side, i.e., the left, from the lateral center (C1) of the main body 10. As an example, the lateral center (C2) of the rear fan assembly 100 may be disposed at a position offset to the left from the lateral center (C1) of the main body 10.

For example, the fan motor of the rear fan assembly 100 may be disposed at a position offset to the left from the lateral center (C1) of the main body 10, and the distance between the left end of the rear fan assembly 100 and the left end of the main body 10 may be set shorter than the distance between the right end of the rear fan assembly 100 and the right end of the main body 10.

In this case, the lateral center (C2) of the rear fan assembly 100 may be disposed at a position that is offset from the lateral center (C3) of the third exhaust port 4 disposed at the lateral center (C1) of the main body 10 in a direction away from the corner fan assembly 200. That is, the rear fan assembly 100 may be disposed at a position offset to the left relative to the third exhaust port 4.

Also, in this case, the lateral center (C3) of the third exhaust port 4 may be disposed between the corner fan assembly 200 and the lateral center (C2) of the rear fan assembly 100 disposed as described above. That is, the third exhaust port 4 may be disposed at the lateral center (C1) of the main body 10, and may be disposed at a position offset to the right with respect to the rear fan assembly 100.

As an example, at least a portion of the rear fan assembly 100 and the corner fan assembly 200 may be disposed laterally outside the third exhaust port 4. For example, the corner fan assembly 200 may be disposed laterally outside the third exhaust port 4, wherein it may be disposed at one lateral side, i.e., the right side, of the third exhaust port 4. And at least a portion of the rear fan assembly 100 may be disposed laterally outside the third exhaust port 4, wherein it may be disposed at the other lateral side, i.e., the left side of the third exhaust port 4.

As an example, the one among the pair of first discharge ports 114 provided in the rear fan assembly 100, which is disposed at the right side may be disposed at the lateral inner region of the third exhaust port 4. And at least a portion of the one among the pair of first discharge ports 114 provided in the rear fan assembly 100, which is disposed at the left side may be disposed at a region out of the third exhaust port 4 to the left.

Typically, the lateral positions of the third exhaust port 4 and the first exhaust port 2 are set to the lateral center of the cooking appliance. The third exhaust port 4 may be connected with a pipe or duct embedded in the wall on which the cooking appliance is installed, and the first exhaust port 2 may be connected with a pipe or duct embedded in the wall or ceiling on which the cooking appliance is installed.

The location of the pipe or duct connected with the third exhaust port 4 is generally set to a location that is determined by taking into consideration that the lateral location of the third exhaust port 4 is disposed at the lateral center of the cooking appliance. That is, the location of the pipe or duct to be connected to the third exhaust port 4 is generally set to a location where the pipe or duct can be connected in a straight line in front and rear direction with the third exhaust port 4 disposed at the lateral center of the cooking appliance when the cooking appliance is installed in the set location.

Therefore, if the third exhaust port 4 is not disposed at the lateral center of the cooking appliance, it becomes difficult to properly connect the third exhaust port 4 and the pipe or duct embedded in the wall on which the cooking appliance is installed. Taking this point into consideration, in the cooking appliance of the present embodiment, the third exhaust port 4 is disposed at the lateral center (C1) of the main body 10.

According to the present embodiment, compared to the third exhaust port 4 disposed at the lateral center (C1) of the main body 10, the rear fan assembly 100 may be disposed at a location slightly offset to the left from the lateral center (C1) of the main body 10.

In the rear space section 10f, not only the rear fan assembly 100 but also the corner fan assembly 200 are disposed together, and the rear fan assembly 100 and the corner fan assembly 200 are disposed to be spaced apart from each other by a predetermined distance in a lateral direction. The rear fan assembly 100 sucks air through the first suction port 112 disposed at the side of the rear fan assembly 100, and the corner fan assembly 200 discharges air through the second discharge port 214 disposed at the side of the corner fan assembly 200.

One of the first suction ports 112 is disposed at a side facing the corner fan assembly 200, and the second discharge port 214 is disposed at the side facing the rear fan assembly 100. That is, the second discharge port 214 and the the first suction port 112 disposed at the right side of the rear fan assembly 100 are disposed to face each other in a lateral direction.

Accordingly, at least a portion of the rear fan assembly 100 is disposed laterally outside the third exhaust port 4. For example, a portion of the left side of the rear fan assembly 100 may be disposed laterally outside the third exhaust port 4.

### [Overall Structure of Exhaust Guide Member]

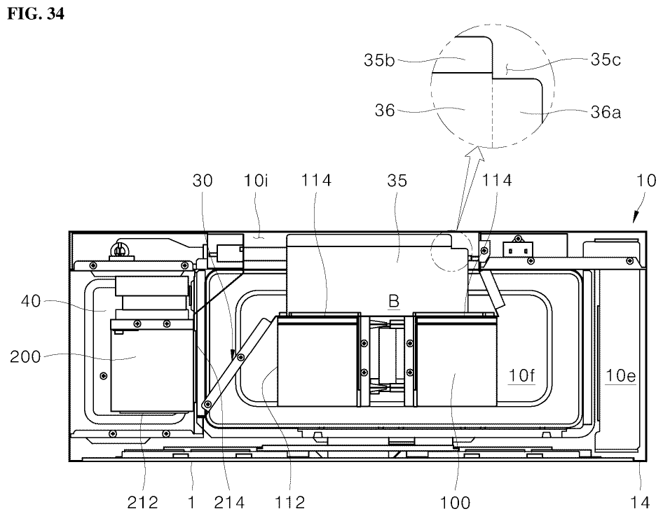

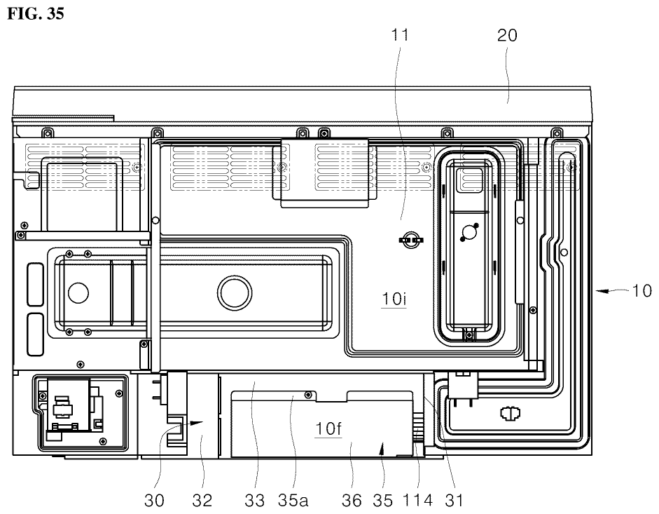

FIG. 31 is a rear view showing the state in which the exhaust guide member is installed inside the cooking appliance, and FIG. 32 is a cross-sectional side view showing the internal structure of the cooking appliance illustrated in FIG. 31. Additionally, FIG. 33 is a rear perspective view showing the state in which the cabinet and the rear plate are removed from the cooking appliance illustrated in FIG. 31, and FIG. 34 is a rear view of the cooking appliance illustrated in FIG. 33, and FIG. 35 is a plan view of the cooking appliance illustrated in FIG. 33.

Referring to FIGS. 31 to 35, a cooking appliance according to one embodiment of the present invention may further include an exhaust guide member 35. The exhaust guide member 35 is provided to guide the flow of air discharged from the wind blowing part 100, 200.

As an example, in the case where the cooking appliance is used in the third state (see FIGS. 16 and 17), that is, in the case where the cooking appliance is used so that cooking fumes sucked into the inside of the cooking appliance can be discharged to the outside through the third exhaust port 4, the exhaust guide member 35 may be installed in the cooking appliance.

For example, in the case where the cooking appliance is used in the first state or the second state, that is, in the case where the cooking appliance is used so that cooking fumes sucked into the inside of the cooking appliance can be discharged to the outside through the first exhaust port 2 or the second exhaust port 3, the exhaust guide member 35 is not installed in the cooking appliance, whereas only when the cooking appliance is used in the third state, the exhaust guide member 35 can be installed in the cooking appliance.

According to the present embodiment, the first discharge port 114 is disposed at the top surface of the rear fan assembly 100. The exhaust guide member 35 may be disposed at the upper side of the first discharge port 114. Additionally, the third exhaust port 4 may be disposed at the upper side of the first discharge port 114. And at least a portion of the exhaust guide member 35 may be disposed between the first discharge port 114 and the third exhaust port 4.

At least a portion of the exhaust guide member 35 may be disposed to block between the rear plate 15 and the cavity 11. As an example, the exhaust guide member 35 may be disposed at the rear space section 10f, and may be disposed to block between the rear surface of the cavity 11 and the rear plate 15. This exhaust guide member 35 can form a rear guide flow path (B) inside the cooking appliance.

The rear guide flow path (B) is provided to guide the flow of air discharged from the wind blowing part 100, 200 toward the third exhaust port 4. As an example, the rear guide flow path (B) may be disposed at the rear space section 10f. This rear guide flow path (B) can connect between the wind blowing part 100, 200 and the third exhaust port 4, and can be formed in a space surrounded by the wind blowing part 100, 200, the rear plate 15, and the exhaust guide member 35.

The entrance of this rear guide flow passage (B) may be opened toward the wind blowing part 100, 200. For example, the entrance of the rear guide flow path (B) may be opened toward the first discharge port 114 of the rear fan assembly 100 and the second outlet 214 of the corner fan assembly 200. And the exit of the rear guide flow path (B) may be opened toward the third exhaust port 4.

Additionally, at least a portion of the exhaust guide member 35 may be disposed to block between the third exhaust port 4 and the top space section 10i. In addition, at least a portion of the exhaust guide member 35 may be disposed to block between the first discharge port 114 and the top space section 10i. That is, the exhaust guide member 35 may form a wall that blocks the passage between the third exhaust port 4 and the top space section 10i and blocks the passage between the first discharge port 114 and the top space section 10i.

Accordingly, the rear guide flow path (B) can be formed in a space that is opened only toward the wind blowing part 100, 200 and the third exhaust port 4 and is blocked from the top space section 10i. At this time, at least a portion of the exhaust guide member 35 may be disposed to form an upper boundary surface of the rear guide flow path (B) and block between the rear guide flow path (B) and the top space section 10i.

According to the present embodiment, the exhaust guide member 35 may form a guide plate 36. The guide plate 36 can form most of the frame and exterior of the exhaust guide member 35. This guide plate 36 can form a wall blocking between the first discharge port 114 and the top space section 10i. Additionally, the guide plate 36 can form a wall blocking between the third exhaust port 4 and the top space section 10i.

According to the present embodiment, the guide plate 36 can be disposed at the upper side of the rear guide flow path (B). As an example, the guide plate 36 may form an inclined wall that blocks between the first discharge port 114 and the top space section 10i, and between the top space section 10i and the third exhaust port 4.

As an example, at least a portion of the guide plate 36 may be disposed between the first discharge port 114 and the third exhaust port 4, and a portion of the guide plate 36 may be disposed at the upper side of the third exhaust port 4.

That is, with respect to an up and down direction, the third exhaust port 4 may be disposed at the upper side of the first discharge port 114, the lower end of the guide plate 36 may be disposed between the first discharge port 114 and the third exhaust port 4, and the most region of the guide plate 36 may be disposed between the first discharge port 114 and the third exhaust port 4. And the upper end of the guide plate 36 may be disposed at the upper side of the first discharge port 114.

Additionally, a portion of the guide plate 36 may be disposed at the front side of the first discharge port 114, and at least a portion of the guide plate 36 may be disposed between the first discharge port 114 and the third exhaust port 4.

That is, with respect to a front and rear direction, the first discharge port 114 may be disposed at the front side of the third exhaust port 4, and the lower end of the guide plate 36 may be disposed at the front side of the first discharge port 114. And the upper end of the guide plate 36 may be disposed between the first discharge port 114 and the third exhaust port 4, and the most region of the guide plate 36 may be disposed between the first discharge port 114 and the third exhaust port 4.

For example, the guide plate 36 may be formed in a form of an inclined surface that slopes upward toward the rear from the front side of the first discharge port 114 and the lower side of the third exhaust port 4. Accordingly, the rear guide flow path (B) can form an inclined passage that rises from the first discharge port 114 toward the third exhaust port 4.

### [Combining Structure Between Rear Fan Assembly and Exhaust Guide Member]

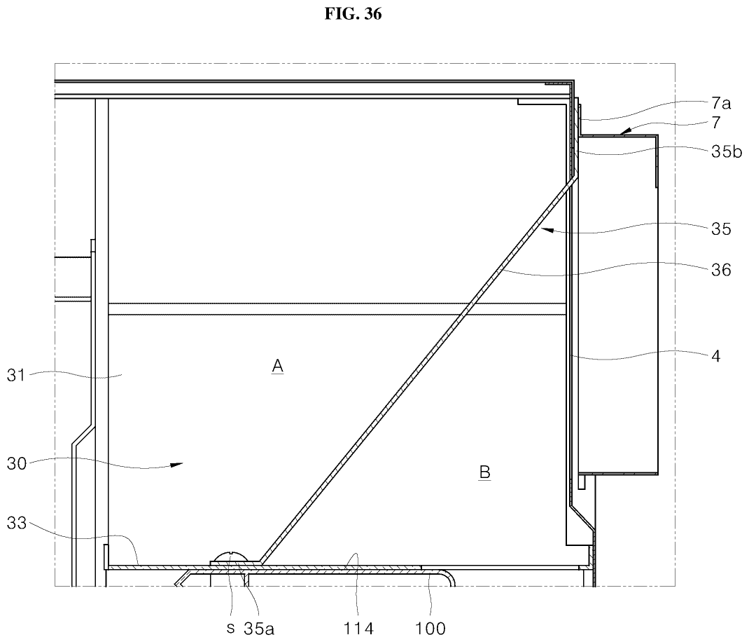

FIG. 36 is a cross-sectional side view showing a portion of the cooking appliance illustrated in FIG. 31 in a magnified state.

Referring to FIGS. 35 and 36, the guide plate 36 according to the present embodiment may further include a lower combining part 35a. The lower combining part 35a is provided to combine the guide plate 36 to the rear fan assembly 100.

The lower combining part 35a may be connected with the rear fan assembly 100 at the lower side of the guide plate 36. As an example, the lower combining part 35a may be formed in a form in which it protrudes from the lower end of the guide plate 36. This lower combining part 35a can combine the guide plate 36 to the rear fan assembly 100 by being combined to the top surface of the rear fan assembly 100. In this embodiment, the lower combining part 35a is, by way of example, combined to the rear fan assembly 100 at the upper side and the front side of the first discharge port 114.

According to the present embodiment, the fastening plate 33 may be installed on the top surface of the rear fan assembly 100. This fastening plate 33 may be provided in a form in which it forms a plane parallel to the top surface of the rear fan assembly 100, and may be combined to the rear fan assembly 100. In this regard, the fastening plate 33 may cover the top surface of the rear fan assembly 100, while allowing the first discharge port 114 to be opened upward.

The fastening plate 33 may be combined to the rear fan assembly 100 by a fastening member(s). As an example, the fastening member(s) may be provided in a form of a screw. These fastening member(s) can penetrate through the fastening plate 33 and the rear fan assembly 100 in an up and down direction, and combine the fastening plate 33 to the rear fan assembly 100.

In the case where the cooking appliance is used in the first state (see FIGS. 12 and 13) or the second state (see FIGS. 14 and 15), the rear fan assembly 100 and the fastening plate 33 may be connected with each other by the fastening member(s).

In this embodiment, the lower combining part 35a is, by way of example, combined to the fastening plate 33. This lower combining part 35a can combine the guide plate 36 to the rear fan assembly 100 by being combined to the fastening plate 33.

As an example, the lower combining part 35a may be formed in a form in which it protrudes forward from the lower end of the guide plate 36. This lower combining part 35a can form a plane parallel to the horizontal plane formed by the fastening plate 33, and can be combined to the fastening plate 33 in a state of abutting against the fastening plate 33 in an up and down direction.

As an example, the lower combining part 35a may be combined to the fastening plate 33 by the fastening member(s). According to this, the fastening member(s) can penetrate through the top surface of the rear fan assembly 100, the fastening plate 33, and the lower combining part 35a together, and can combine the fastening plate 33 and the lower combining part 35a to the top surface of the rear fan assembly 100.

According to the present embodiment, in the case where the cooking appliance has been manufactured in the first state or the second state, or is used in the first state or the second state, the rear fan assembly 100 and the fastening plate 33 are combined to each other by the fastening member(s), and the head of the fastening member(s) is exposed to the upper side of the fastening plate 33.

In case of wanting to use the cooking appliance of this state in the third state, the fastening member(s) fastened to the rear pan assembly 100 and the fastening plate 33 can be removed from the rear pan assembly 100 and the fastening plate 33, and then the lower combining part 35a can be combined to the fastening plate 33 and the rear pan assembly 100 using the fastening member(s) which has been thus removed.

That is, the fastening member(s) used to install the flow path forming member 30 to the rear fan assembly 100 can be used as itself to install the flow path forming member 30 and the exhaust guide member 35 to the rear fan assembly 100.

### [Combining Structure Between Rear Plate and Exhaust Guide Member]

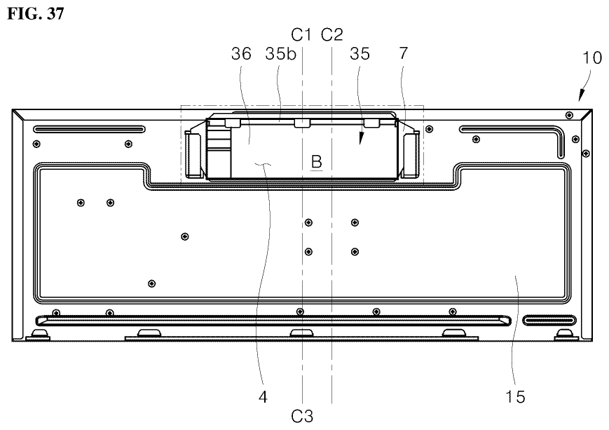

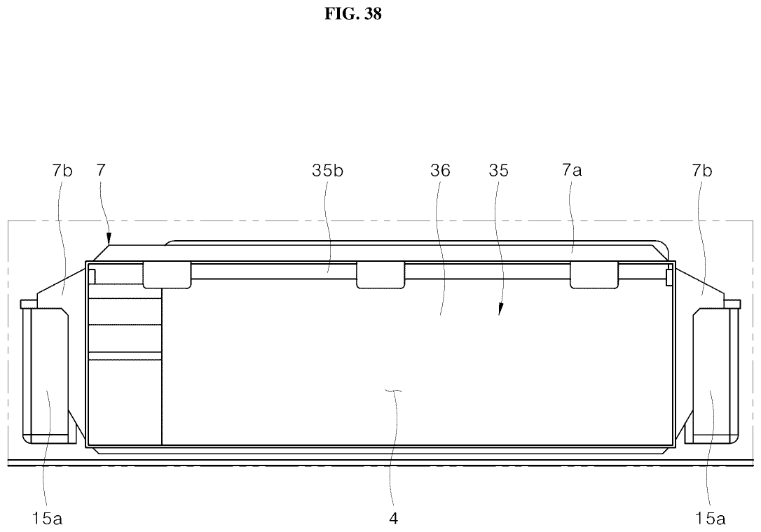

FIG. 37 is a rear view of the cooking appliance illustrated in FIG. 31, and FIG. 38 is an enlarged view showing a portion of the cooking appliance illustrated in FIG. 37 in a magnified state.

Referring to FIG. 34, FIGS. 36 and 37, the guide plate 36 according to the present embodiment may further include an upper combining part 35b. The upper combining part 35b is provided to combine the guide plate 36 to the main body 10, more specifically, to the rear surface of the main body 10.

The upper combining part 35b may be connected with the guide plate 36 at the upper side of the guide plate 36. As an example, the upper combining part 35b may be formed in a form in which it protrudes from the upper end of the guide plate 36. This upper combining part 35b can combine the guide plate 36 to the rear surface of the main body 10 by being combined to the rear surface of the main body 10. In this embodiment, the upper combining part 35b is, by way of example, combined to the rear plate 15 at the upper side of the third exhaust port 4.

As an example, the upper combining part 35b may extend upward from the guide plate 36, and protrude to the back side of the main body 10 through the third exhaust port 4. For example, the upper combining part 35b may pass through the third exhaust port 4, and protrude toward the rear of the rear plate 15. This upper combining part 35b may be combined to the rear surface of the main body 10 at the upper side of the third exhaust port 4 and the back side of the main body 10.

Meanwhile, the cooking appliance of the present embodiment may further include an adapter 7. The adapter 7 may be installed on the rear surface of the main body 10, and is provided so that it can be connected to a duct (Da) to be connected to the third exhaust port 4. This adapter 7 may be combined to the rear surface of the main body 10, more specifically, to the rear plate 15, at the lateral outside of the third exhaust port 4.

As an example, the adapter 7 may be provided in a form of a rectangular frame with a hollow portion formed therein. This adapter 7 may be installed on the rear surface of the main body 10 in a form in which it protrudes rearward from the rear plate 15. The hollow portion formed inside the adapter 7 may be communicated with the third exhaust port 4 in a front and rear direction, and may be formed in a shape corresponding to the shape of the third exhaust port 4.

The duct (Da) may be fitted to the outside of the adapter 7 protruding rearward from the rear surface of the main body 10, so that it can be combined with the adapter 7. By combining the duct (Da) with the adapter 7 in this manner, the duct (Da) can be installed on the rear surface of the cooking appliance to be connected with the third exhaust port 4.

Additionally, a damper (Db) may be disposed inside the duct (Da). The damper (Db) may be provided to be combined to the adapter 7 so that it is rotatable around the upper end to open and close the flow path formed inside the duct (Da).

The adapter 7 may include an upper protruding surface 7a disposed at the upper side of the hollow portion, as shown in FIGS. 36 to 38. The upper protruding surface 7a may be formed in a form of a vertical plate that forms a plane parallel to the rear plate 15. This upper protrusion surface 7a can abut against the rear surface of the main body 10 in a front and rear direction. In addition, the upper protruding surface 7a can maintain a state of being in close contact with the rear surface of the main body 10 when the adapter 7 is combined to the rear surface of the main body 10.

As an example, the upper protruding surface 7a may be in close contact with the rear plate 15. As another example, the upper protruding surface 7a may abut against a portion of the cabinet 13 that covers a portion of the rear surface of the rear plate 15.

The adapter 7 may further include a side protruding surface 7b disposed at a side of the hollow portion. As an example, a pair of side protruding surfaces 7b may be disposed spaced apart from each other in a lateral direction with the hollow portion interposed therebetween. That is, side protruding surfaces 7b may be provided on opposite sides of the adapter 7, respectively.

On the rear surface of the main body 10, there may be provided a structure for combining the side protruding surface 7b to the main body 10. As an example, a pair of fitting parts 15a may be disposed spaced apart from each other in a lateral direction on the rear plate 15 with the third exhaust port 4 interposed therebetween.

As an example, each fitting part 15a may be disposed at the lateral outside of the third exhaust port 4, and may be formed in a form in which it protrudes rearward from the rear plate 15. For example, the fitting part 15a may be formed in a form in which it protrudes from the rear plate 15 in an “L” shape.

Between the fitting part 15a provided in this manner and the rear plate 15, there may be formed a fitting space, which may be opened toward a side and upward. The side protruding surface 7b can be fitted into and combined with the fitting part 15a in a form in which it is inserted into this fitting space. For example, the side protruding surface 7b may be fitted into the fitting part 15a while moving from the upper side to the lower side of the fitting part 15a.

In a state where the side protruding surface 7b is fitted into the fitting part 15a in this manner, a fastening member such as a screw or the like can secure them. The fastening member can penetrate through the side protruding surface 7b and the fitting part 15a in a front and rear direction from the back side of the side protruding surface 7b to secure the fitting part 15a to the side protruding surface 7b.

When the side protruding surface 7b and the fitting part 15a are combined to each other as described above, the adapter 7 can be combined to the rear plate 15, and the upper protruding surface 7a can be brought into close contact with the rear surface of the main body 10. That is, the adapter 7 can be combined to the rear surface of the main body 10 at the lateral outside of the third exhaust port 4, and the upper protruding surface 7a can be in close contact with the rear surface of the main body 10 at the upper side of the third exhaust port 4.

The upper combining part 35b may be fixed between the rear surface of the main body 10 and the adapter 7 installed on the rear surface of the main body 10 as described above. As an example, the upper combining part 35b may be fitted between the rear surface of the main body 10 and the upper protruding surface 7a at the upper side of the third exhaust port 4. That is, the upper combining part 35b may be combined to the rear surface of the main body 10 in a form in which it is inserted between the upper protruding surface 7a and the rear surface of the main body 10 which abut against each other in a front and rear direction.

Hereinafter, an example of the installation process of the exhaust guide member 35 will be described.

Referring to FIGS. 35 and 36, in order to install the exhaust guide member 35, the cabinet can be first removed from the main body 10, and then the fastening member(s) fastened to the fastening plate 33 can be separated. Thereafter, using the fastening member(s) separated as described above, the fastening plate 33 and the lower combining part 35a can be combined together to the top surface of the rear fan assembly 100.

In other words, the exhaust guide member 35 can be combined to the rear fan assembly 100 together with the flow path forming member 30 by the fastening member(s) which has been used to install the flow path forming member 30 to the rear fan assembly 100.

As described above, in a state where the bottom of the exhaust guide member 35 is combined to the rear fan assembly 100, as shown in FIGS. 36 to 38, at least a portion of the exhaust guide member 35, more specifically, the upper combining part 35b, can protrude to the outside of the main body 10 through the third exhaust port 4.

The upper combining part 35b that passes through the third exhaust port 4 in this way may be disposed at the back side of the rear plate 15, and may be disposed at the upper side of the third exhaust port 4. In this regard, the upper combining part 35b may be disposed parallel to the rear surface of the main body 10.

In this state, when the adapter 7 is combined to the rear plate 15 from the back side of the upper combining part 35b, the upper combining part 35b is fitted between the rear surface of the main body 10 and the upper protruding surface 7a of the adapter 7. The upper combining part 35b fitted between the main body 10 and the adapter 7 in this way can be fixed to the main body 10 by being pressed against the rear surface of the main body 10 by the adapter 7 pressing the upper combining part 35b forward.

That is, the upper part of the exhaust guide member 35 can be combined to the rear surface of the main body 10 by the operation of installing the adapter 7 on the cooking appliance.

As described above, the exhaust guide member 35 of the present embodiment can be effectively installed in the cooking appliance without adding a separate part for installation of the exhaust guide member 35. In addition, the exhaust guide member 35 of the present embodiment can be installed together with the corresponding component without adding any additional work to the process of installing the component required to use the cooking appliance in the third state, so it has the advantage of being able to be installed in the cooking appliance easily, quickly, and conveniently.

### [Relationship Between the Location of the Third Exhaust Port and the Location of the Exhaust Guide Member]

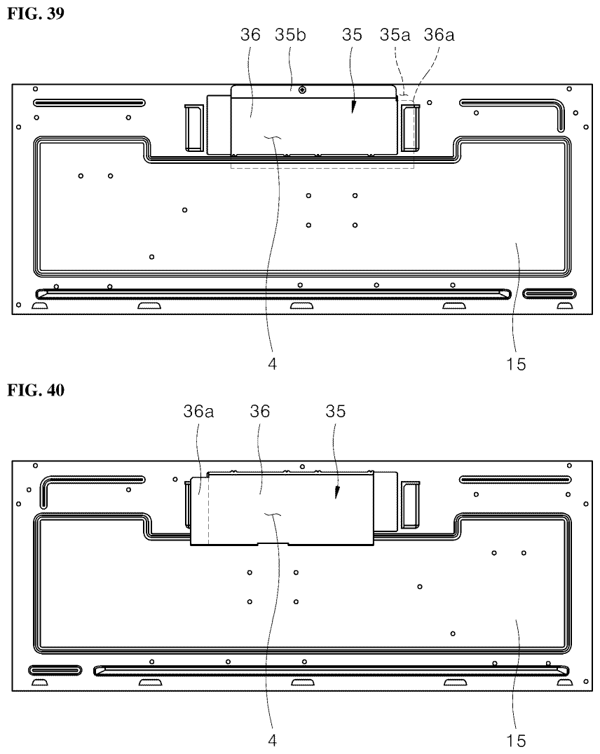

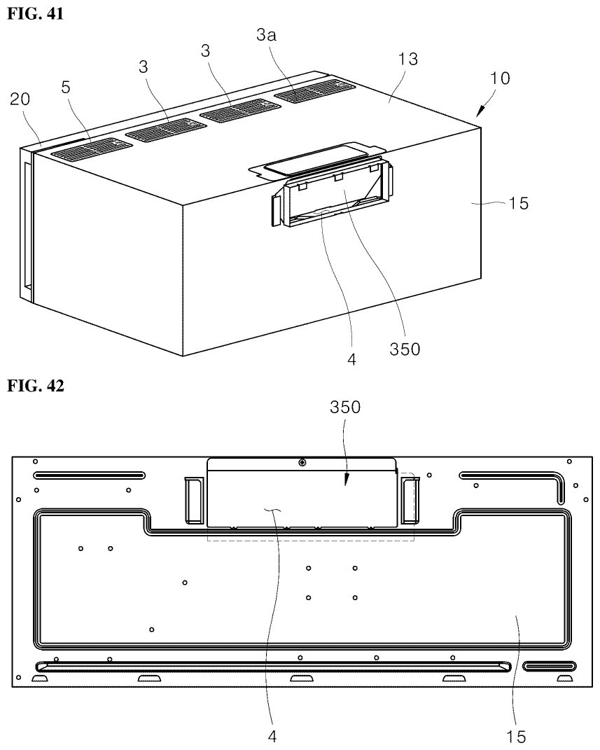

Further, FIG. 39 is a rear view showing the rear plate and exhaust guide member in a separate state, and FIG. 40 is a front view showing the rear plate and the exhaust guide member in a separate state. Additionally, FIG. 41 is a rear perspective view of the cooking appliance showing another example of the exhaust guide member, and FIG. 42 is a front view showing the rear plate and the exhaust guide member illustrated in FIG. 41 in a separate state.

Referring to FIGS. 33 to 35, the guide plate 36 may be disposed within the width of the rear fan assembly 100. That is, with respect to a lateral direction, the guide plate 36 may be disposed at the inside of the rear fan assembly 100. The guide plate 36 disposed in this manner can guide, toward the third exhaust port 4, the flow of air discharged from the first discharge port 114 of the rear fan assembly 100.

Referring to FIGS. 37 to 39, the lateral length of the guide plate 36 may be set to be less than or equal to the lateral length of the third exhaust port 4. That is, the guide plate 36 may be formed to have the length that can pass through the third exhaust port 4.

Referring to FIGS. 39 and 40, at least a portion of the guide plate 36 may be disposed at the lateral outside of the third exhaust port 4. That is, with respect to the third exhaust port 4, the guide plate 36 may be disposed at a position offset to the other side from the lateral center (C3) of the third exhaust port 4.

As an example, a part of the guide plate 36 may be disposed at the other lateral side, i.e., the left side, of the third exhaust port 4. In this embodiment, the exhaust guide member 35 further includes, by way of example, a side plate 36a. The side plate 36a is a portion that extends from the guide plate 36 in a lateral direction.

As an example, a portion of the guide plate 36 disposed on the other lateral side of the third exhaust port 4 may correspond to the side plate 36a. That is, the side plate 36a may be a portion extending to the left from the guide plate 36, and may be disposed at the left side of the third exhaust port 4.

On the upper side of the side plate 36a, there may be provided a notch 38c. The notch 38c may be formed as a space surrounded by the upper end of the side plate 36a and a side end of the upper combining part 35b.

As an example, the notch 38c may be formed in a form in which a portion of the upper left side of the upper combining part 35b is cut off. This notch 38c may be disposed at the outside of the third exhaust port 4. That is, on the vertical plane formed by the rear surface of the main body 10, the notch 38c may be disposed at the outside of the third exhaust port 4.

According to the present embodiment, the sum of the lateral length of the guide plate 36 and the lateral length of the side plate 36a is set greater than the lateral length of the upper combining part 35b. That is, the lateral length of the entire guide plate 36 including the side plate 36a may be formed greater than the lateral length of the upper combining part 35b. This is due to the formation of the notch 38c on the side of the upper combining part 38.

And the lateral length of the upper combining part 35b may be formed to be less than or equal to the lateral length of the third exhaust port 4. Accordingly, with the guide plate 36 disposed at the front side of the rear plate 15, the upper combining part 35b connected to the guide plate 36 can pass through the third exhaust port 4, and be combined to the rear surface of the rear plate 15.

In this regard, the side plate 36a is disposed at the lateral outside of the third exhaust port 4, the upper combining part 35b is disposed at the upper side of the third exhaust port 4, and the notch 38c is disposed at the upper side and lateral outside of the third exhaust port 4. That is, due to the presence of the notch 38c, the upper combining part 35b can be combined to the rear surface of the main body 10 at the back side of the rear plate 15 while the side plate 36a is disposed at the lateral outside of the third exhaust port 4.

Referring to FIG. 32 and FIGS. 36 to 40, when the cooking appliance is used in the third state, air discharged from the rear fan assembly 100 can flow toward the third exhaust port 4 by the rear guide flow path (B) formed by the exhaust guide member 35, and can be discharged to the outdoors through the duct (Da) connected to the third exhaust port 4.

In order for the air flow discharged from the rear fan assembly 100 to be smoothly guided to the third exhaust port 4, it is preferable that the rear guide flow path (B) be formed at the top of the rear fan assembly 100 so as to span the entire lateral area of the rear fan assembly 100. To this end, it is preferable that the exhaust guide member 35 forming the rear guide flow path (B), particularly the guide plate 36, be disposed so as to cover most of the rear fan assembly 100 from the upper side.

One method for this would be to install, in the cooking appliance, the exhaust guide member 35 formed to have a size large enough to completely cover the entire area of the rear fan assembly 100 from the upper side. However, as the size of the exhaust guide member 35 increases, restriction of the installation space grows making it more difficult to install the exhaust guide member 35, and there is also concern about interference between the components constituting the flow path forming member 30 and the exhaust guide member 35.

In this embodiment, the lateral length of the rear fan assembly 100 is, by way of example, similar to the lateral length of the third exhaust port 4. And the lateral length of the guide plate 36 is, by way of example, less than or equal to the lateral length of the third exhaust port 4.

As an example, the lateral length of the guide plate 36 may be set to a length that allows the guide plate 36 to pass through the third exhaust port 4, and to be disposed at the lateral inside of the rear fan assembly 100. Hereinafter, the aforementioned lateral length of the guide plate 36 is referred to as the “preset width.”

In the state where the rear fan assembly 100 is disposed as described above, it is impossible for the guide plate 36 formed to have the preset width to completely cover the rear fan assembly 100 from the upper side while, at the same time, completely covering the third exhaust port 4 from the front.

The main role of the guide plate 36 is to guide the flow of air discharged from the rear fan assembly 100 toward the third exhaust port 4. Therefore, it is preferable that the position of the guide plate 36 be set to a position that can allow it to cover the upper side of the region where air is discharged from the rear fan assembly 100, that is, the region where the first discharge port 114 is disposed.

Taking this point into consideration, in this embodiment, the guide plate 36 is disposed so that the guide plate 36 can cover a region as wide as possible of the rear fan assembly 100, even if it cannot completely cover the third exhaust port 4 from the front.

As an example, the lateral length of the rear fan assembly 100 may be set to a length corresponding to the preset width, and the guide plate 36 may be disposed at the lateral inside of the rear fan assembly 100. Accordingly, the guide plate 36 is disposed at a position offset to the left relative to the third exhaust port 4.

For example, the left portion of the guide plate 36, that is, the side plate 36a, is disposed to the outside of the third exhaust port 4. And, around a right portion of the third exhaust port 4, there exists a region (hereinafter, referred to as “unblocked region”) where the front side of the third exhaust port 4 is not blocked by the guide plate 36.

The left portion of the guide plate 36 disposed at the outside of the third exhaust port 4 can be effectively involved in guiding the flow of air discharged from the rear fan assembly 100 toward the third exhaust port 4.

And the unblocked region is a region disposed at a position deviated from the region where air is discharged from the rear fan assembly 100. Therefore, even if exhaust guide in this region is not properly performed, the resultant loss would be minimal compared to the effect of the flow path resistance reduction obtained by the action of the side plate 36a.

The exhaust guide member 35 of the present embodiment, which is installed as described above, can be formed in a shape and size suitable for installation inside the cooking appliance, so that it can be easily installed inside the cooking appliance, while, at the same time, it can effectively guide the flow of air discharged from the rear fan assembly 100 toward the third exhaust port 4.

As another example, as shown in FIGS. 41 and 42, the exhaust guide member 350 may be provided to cover the entire third exhaust port 4 from the front side. The exhaust guide member 350 provided in this manner can minimize the occurrence of the unblocked region, and further improve the effect of the flow path resistance reduction obtained by the action of the side plate 36a.

Meanwhile, referring to FIGS. 36 to 40, in the present embodiment, the third exhaust port 4 is disposed at the lateral center (C1) of the main body 10. And the rear fan assembly 100 is disposed at a position offset to the left from the lateral center (C1) of the main body 10, so that a sufficient distance can be secured between the first suction port 112 of the rear fan assembly 100 and the second discharge port 214 of the corner fan assembly 200.

Accordingly, at least a portion of the rear fan assembly 100 is disposed laterally outside the third exhaust port 4. For example, a portion of the left side of the rear fan assembly 100 may be disposed laterally outside the third exhaust port 4.

In this case, a portion of the region where air is discharged from the rear fan assembly 100 has no choice but to be disposed at the lateral outside of the third exhaust port 4. That is, a portion of the left side of the region where air is discharged from the rear fan assembly 100 may be disposed at a position offset to the right beyond the left boundary of the third exhaust port 4.

If the distance between the rear fan assembly 100 and the corner fan assembly 200 is too close, the distance between the second discharge port 214 and the first suction port 112 disposed at the right side of the rear fan assembly 100 becomes too close. This case may lead to a problematic situation where the space around the first suction port 112 becomes too narrow and air suction through the first suction port 112 is not performed properly, or where the space around the second discharge port 214 becomes too narrow and air discharge through the second discharge port 214 is not performed properly.

Taking this point into consideration, in the cooking appliance of the present embodiment, the rear fan assembly 100 is disposed at a position offset to the left from the lateral center (C1) of the main body 10. That is, the rear fan assembly 100 of the present embodiment may not be disposed at the lateral center (C1) of the main body 10 or at a position offset to the right from the lateral center (C1) of the main body 10, but may be disposed at a position slightly offset to the left from the corner fan assembly 200 compared to the lateral center (C1) of the main body 10.

By disposing the rear fan assembly 100 at a position offset to the left from the lateral center (C1) of the main body 10 in this way, a sufficient distance can be secured between the first suction port 112 disposed at the right side of the rear fan assembly 100 and the second discharge port 214 disposed at the left side of the corner fan assembly 200.

Accordingly, the lateral position of the rear fan assembly 100 relative to the third exhaust port 4 will be a position slightly offset to the left, but the benefit gained by securing sufficient distance between the rear fan assembly 100 and the corner fan assembly 200 is greater than the slight loss caused by this.

For example, the air flow from the rear fan assembly 100 to the third exhaust port 4 may be formed in a form in which it is bent slightly in a lateral direction, and thus the resistance to this flow may increase somewhat. However, the resistance to the flow of air sucked in through the second suction port 212 and the resistance to the flow of air discharged through the first discharge port 114 can be significantly reduced, and accordingly, the discharge flow rate of the rear fan assembly 100 and the corner fan assembly 200 can be effectively increased.

That is, even if the resistance to the flow of air from the rear fan assembly 100 to the third exhaust port 4 increases to a certain degree, the effect caused by this can be sufficiently compensated by the effect of increased discharge flow rate of the rear fan assembly 100 and the corner fan assembly 200, and exhaust through the third exhaust port 4 can even be made more smoothly.

Additionally, in this embodiment, the exhaust guide member 35 is installed between the air discharge side of the rear fan assembly 100 and the third exhaust port 4, so that the exhaust flow through the third exhaust port 4 can be more effectively guided.

The exhaust guide member 35 can form a passage, i.e., the rear guide flow path (B), that blocks the passage between the wind blowing part 100, 200 and the top space section 10i while simultaneously guiding the flow of air discharged from the wind blowing part 100, 200 toward the third exhaust port 4. This exhaust guide member 35 can contribute to smoothly guiding exhaust flow from the wind blowing part 100, 200 toward the third exhaust port 4 while lowering the flow path resistance around the third exhaust port 4.

That is, since the cooking appliance of the present embodiment can effectively increase the discharge flow rate of the wind blowing part 100, 200 by making it possible to secure a sufficient distance between the rear fan assembly 100 and the corner fan assembly 200, and can effectively guide the exhaust flow from the wind blowing part 100, 200 toward the third exhaust port 4 by means of the exhaust guide member 35, thereby enabling the exhaust through the third exhaust port 4 to be performed more smoothly, it can achieve the further improved performance in providing the hood function.

The purpose of the present invention is to provide a cooking appliance whose structure is improved so that it can provide a hood function while suppressing an increase in the vertical length of the entire cooking appliance.

In addition, another purpose of the present invention is to provide a cooking appliance whose structure is improved so that outdoor exhaust can be smoothly performed through a pipe or duct embedded in a wall on which the cooking appliance is installed.

In addition, still another purpose of the present invention is to provide a cooking appliance whose structure is improved so that it can ensure the low flow path resistance and smooth exhaust flow inside the cooking appliance.

In addition, still yet another purpose of the present invention is to provide a cooking appliance which can be installed and maintained with easy.

A cooking appliance, which is an embodiment of the present invention for achieving the above purposes, is characterized in that a rear space section is disposed at the back side of a cooking chamber inside a main body to be communicated with an exhaust port, and an exhaust guide member forms a rear guide flow path that guides the flow of air discharged from a wind blowing part toward the exhaust port, wherein the rear guide flow path is disposed at the rear space portion.

In addition, another embodiment of the present invention is characterized in that at least one fan assembly is disposed at a rear space section, which is a space between the rear surface of a cavity forming a cooking chamber therein and a rear plate forming a rear exterior of a cooking appliance, and at least one flow path member formed by a plurality of flow path plates disposed at the rear space section forms a passage connecting between the fan assembly and an exhaust port, and guides an exhaust flow.

A cooking appliance according to one aspect of the present invention may include: a main body forming a cooking chamber therein and provided with an intake port and an exhaust port; a wind blowing part sucking in air through the intake port and discharging the sucked air toward the exhaust port; and an exhaust guide member guiding a flow of air discharged from the wind blowing part.

Additionally, in the main body, there may be provided a rear space section disposing at a back side of the cooking chamber and communicated with the intake port and the exhaust port, and the exhaust port may be disposed at the back side of the rear space section.

Additionally, the exhaust guide member may form a rear guide flow path guiding the flow of air discharged from the wind blowing part toward the exhaust port.

Preferably, the rear guide flow path may be disposed at the rear space section.

Additionally, the main body may include a cavity forming the cooking chamber therein, and a rear plate disposed at a rear side of the cavity.

Additionally, preferably, the exhaust port is disposed at the rear plate, and at least a portion of the exhaust guide member is disposed to block between the rear plate and the cavity.

Additionally, preferably, the rear guide flow path connects between the wind blowing part and the exhaust port, and is formed in a space surrounded by the wind blowing part, the rear plate, and the exhaust guide member.

Additionally, in the main body, there may be provided a top space section disposing at an upper side of the cooking chamber.

Additionally, preferably, the exhaust port is disposed at the back side of the rear space section and the top space section, and at least a portion of the exhaust guide member is disposed to block between the exhaust port and the top space section.

Additionally, preferably, the rear guide flow path connects between the wind blowing part and the exhaust port.

Additionally, preferably, at least a portion of the exhaust guide member is disposed to block between the rear guide flow path and the top space section.

Additionally, the wind blowing part may include a rear fan assembly disposed at the rear space section.

Additionally, the rear fan assembly may suck in air through a first suction port and discharge the sucked air through a first discharge port.

Additionally, the exhaust guide member may include a guide plate forming a wall blocking between the first discharge port and the top space section.

Additionally, preferably, the guide plate forms an inclined wall blocking between the first discharge port and the top space section, and between the top space section and the exhaust port.

Additionally, preferably, with respect to an up and down direction, the exhaust port is disposed at an upper side of the first discharge port, a lower end of the guide plate is disposed between the first discharge port and the exhaust port, and an upper end of the guide plate is disposed at an upper side of the exhaust port.

Additionally, preferably, with respect to a front and rear direction, the first discharge port is disposed at a front side of the exhaust port, the lower end of the guide plate is disposed at a front side of the first discharge port, and the upper end of the guide plate is disposed between the first discharge port and the exhaust port.

Additionally, the exhaust guide member may include a guide plate forming a wall defining an upper boundary surface of the rear guide flow path, a lower combining part combining the guide plate to the rear fan assembly, and an upper combining part combining the guide plate to the main body.

Additionally, preferably, the first discharge port is formed at the top surface of the rear fan assembly, and the lower combining part is combined to the rear fan assembly at an upper side and a front side of the first discharge port.

Additionally, the present invention may further include a fastening plate opening the first discharge port upward and combined to the top surface of the rear fan assembly.

Additionally, the present invention may further include a fastening member penetrating through the top surface of the rear fan assembly and the fastening plate and the lower combining part together, and fastening the fastening plate and the lower combining part to the top surface of the rear fan assembly.

Additionally, preferably, the exhaust port is formed at the rear surface of the main body.

Additionally, preferably, the upper combining part is combined to the rear surface of the main body at the upper side of the exhaust port.

Additionally, the present invention may further include an adapter configured to be combined with a duct to be connected to the exhaust port.

Additionally, preferably, the adapter is combined to the rear surface of the main body at the outside of the exhaust port.

Additionally, preferably, the rear surface of the main body and the adapter are disposed in a front and rear direction, and the upper combining part is fixed between the rear surface of the main body and the adapter.

Additionally, preferably, the upper combining part is fitted between the rear surface of the main body and the adapter at the upper side of the exhaust port.

Additionally, preferably, the upper combining part extends upward from the guide plate, protrudes toward the back side of the main body through the exhaust port, and is combined to the rear surface of the main body at the upper side of the exhaust port and the back side of the main body.

Additionally, the exhaust guide member may further include a side plate extending from the guide plate in a lateral direction.

Additionally, in an upper side of the side plate, there may be provided a notch.

Additionally, preferably, the notch is formed as a space surrounded by an upper end of the side plate and a side end of the upper combining part.

Additionally, preferably, in the vertical plane formed by the rear surface of the main body, the notch is disposed at the outside of the exhaust port.

Additionally, the wind blowing part may include a corner fan assembly disposed spaced apart from the rear fan assembly by a predetermined distance in a lateral direction.

Additionally, preferably, at least a portion of the exhaust port is disposed at the lateral center of the main body.

Additionally, preferably, the lateral center of the exhaust port is disposed between the lateral center of the rear fan assembly and the corner fan assembly, or the lateral center of the rear fan assembly is disposed at a position offset from the lateral center of the exhaust port in a direction away from the corner fan assembly.

Additionally, preferably, with respect to a lateral direction, at least a portion of the rear fan assembly and the corner fan assembly are disposed outside the exhaust port.

Additionally, preferably, the corner fan assembly is disposed at one lateral side of the exhaust port, and at least a portion of the rear fan assembly is disposed at the lateral outside of the exhaust port, and is disposed at the other lateral side of the exhaust port.

Additionally, preferably, a portion of the guide plate is disposed at the lateral outside of the exhaust port, and is disposed at the other lateral side of the exhaust port.

Additionally, preferably, with respect to a left and right direction, the guide plate is disposed at the inside of the rear fan assembly.

Additionally, preferably, the sum of the lateral length of the guide plate and the lateral length of the side plate is greater than the lateral length of the upper combining part, and the lateral length of the upper combining part is less than or equal to the lateral length of the exhaust port, and in an upper side of the side plate, there is provided a notch.

Additionally, preferably, with respect to the exhaust port, the guide plate is disposed at a position offset to the other side from the lateral center of the exhaust port.

Additionally, preferably, a plurality of the first discharge ports are arranged in a lateral direction, and at least a portion of any one of the plurality of the first discharge ports is disposed at the lateral outside of the exhaust port, and is disposed at the other lateral side of the exhaust port.

Additionally, preferably, the exhaust guide member is disposed at the upper side of the first discharge port, and at least a portion of the exhaust guide member is disposed at the lateral outside of the exhaust port, and is disposed at the other lateral side of the exhaust port.

The cooking appliance of the present invention can provide a hood function while suppressing an increase in the vertical length of the cooking appliance by disposing the wind blowing part for providing the hood function at the back side of the cavity instead of the upper side of the cavity.

In addition, the present invention can effectively reduce resistance to the flow of air sucked into the suction port of the corner fan assembly and resistance to the flow of air discharged through the discharge port of the rear fan assembly by enabling the securing of a sufficient distance between the rear fan assembly and the corner fan assembly which are disposed at the rear space section.

The present invention can effectively improve cooking fumes discharge performance by effectively increasing the discharge flow rates of the rear fan assembly and the corner fan assembly.

In addition, the present invention has the effect of enabling smooth outdoor exhaust through a pipe or duct embedded on a wall on which the cooking appliance is installed, by installing the exhaust guide member around the wind blowing part and the third exhaust port, so that the exhaust guide member can smoothly guide the exhaust flow from the wind blowing part toward the third exhaust port while lowering the flow path resistance around the third exhaust port.

In addition, the present invention can effectively increase the discharge flow rate of the wind blowing part by enabling the securing of the sufficient distance between the rear fan assembly and the corner fan assembly, and, in addition, can allow the exhaust flow from the wind blowing part toward the third exhaust port to be effectively guided through the exhaust guide member.

This invention has the effect of enabling the cooking appliance to provide a hood function of improved performance by enabling smoother exhaust flow through the third exhaust port.

In addition, the present invention can have the effect of lowering the difficulty of installation and maintenance work of a cooking appliance and reducing the time and cost required for installation and maintenance work of a cooking appliance by allowing the exhaust guide member to be installed at once together with other parts when performing the work of installing parts necessary to using a cooking appliance in a third state.

Although the present invention has been described with reference to the embodiments shown in the drawings, these are merely exemplary, and those skilled in the art will understand that various modifications and equivalent other embodiments are possible therefrom. Therefore, the true technical protection scope of the present invention should be determined based on the following claims.

It will be understood that when an element or layer is referred to as being “on” another element or layer, the element or layer can be directly on another element or layer or intervening elements or layers. In contrast, when an element is referred to as being “directly on” another element or layer, there are no intervening elements or layers present. As used herein, the term “and/or” includes any and all combinations of one or more of the associated listed items.

It will be understood that, although the terms first, second, third, etc., may be used herein to describe various elements, components, regions, layers and/or sections, these elements, components, regions, layers and/or sections should not be limited by these terms. These terms are only used to distinguish one element, component, region, layer or section from another region, layer or section. Thus, a first element, component, region, layer or section could be termed a second element, component, region, layer or section without departing from the teachings of the present invention.

Spatially relative terms, such as “lower”, “upper” and the like, may be used herein for ease of description to describe the relationship of one element or feature to another element(s) or feature(s) as illustrated in the figures. It will be understood that the spatially relative terms are intended to encompass different orientations of the device in use or operation, in addition to the orientation depicted in the figures. For example, if the device in the figures is turned over, elements described as “lower” relative to other elements or features would then be oriented “upper” relative to the other elements or features. Thus, the exemplary term “lower” can encompass both an orientation of above and below. The device may be otherwise oriented (rotated 90 degrees or at other orientations) and the spatially relative descriptors used herein interpreted accordingly.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

Embodiments of the disclosure are described herein with reference to cross-section illustrations that are schematic illustrations of idealized embodiments (and intermediate structures) of the disclosure. As such, variations from the shapes of the illustrations as a result, for example, of manufacturing techniques and/or tolerances, are to be expected. Thus, embodiments of the disclosure should not be construed as limited to the particular shapes of regions illustrated herein but are to include deviations in shapes that result, for example, from manufacturing.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

Any reference in this specification to “one embodiment,” “an embodiment,” “example embodiment,” etc., means that a particular feature, structure, or characteristic described in connection with the embodiment is included in at least one embodiment of the invention. The appearances of such phrases in various places in the specification are not necessarily all referring to the same embodiment. Further, when a particular feature, structure, or characteristic is described in connection with any embodiment, it is submitted that it is within the purview of one skilled in the art to effect such feature, structure, or characteristic in connection with other ones of the embodiments.

Although embodiments have been described with reference to a number of illustrative embodiments thereof, it should be understood that numerous other modifications and embodiments can be devised by those skilled in the art that will fall within the spirit and scope of the principles of this disclosure. More particularly, various variations and modifications are possible in the component parts and/or arrangements of the subject combination arrangement within the scope of the disclosure, the drawings and the appended claims. In addition to variations and modifications in the component parts and/or arrangements, alternative uses will also be apparent to those skilled in the art.

What is claimed is:

1. A cooking appliance comprising:
a main body forming a cooking chamber therein and provided with an intake port and an exhaust port;
a wind blowing part sucking in air through the intake port and discharging the sucked air toward the exhaust port; and
an exhaust guide member guiding a flow of air discharged from the wind blowing part, wherein:
in the main body, there is provided a rear space section disposed at a back side of the cooking chamber and communicated with the intake port and the exhaust port;
the exhaust port is disposed at a back side of the rear space section;
the exhaust guide member forms a rear guide flow path guiding the flow of air discharged from the wind blowing part toward the exhaust port; and
the rear guide flow path is disposed at the rear space section.

2. The cooking appliance according to claim 1, wherein:
the main body includes a cavity forming the cooking chamber therein, and a rear plate disposed at a rear side of the cavity;
the exhaust port is disposed at the rear plate; and
at least a portion of the exhaust guide member is disposed to block between the rear plate and the cavity.

3. The cooking appliance according to claim 2, wherein the rear guide flow path connects between the wind blowing part and the exhaust port, and is formed in a space surrounded by the wind blowing part, the rear plate, and the exhaust guide member.

4. The cooking appliance according to claim 1, wherein:
in the main body, there is provided a top space section disposed at an upper side of the cooking chamber;
the exhaust port is disposed at a back side of the top space section and the rear space section; and
at least a portion of the exhaust guide member is disposed to block between the exhaust port and the top space section.

5. The cooking appliance according to claim 4, wherein the rear guide flow path connects between the wind blowing part and the exhaust port, and at least a portion of the exhaust guide member is disposed to block between the rear guide flow path and the top space section.

6. The cooking appliance according to claim 4, wherein:
the wind blowing part includes a rear fan assembly disposed at the rear space section;
the rear fan assembly sucks in air through a first suction port and discharges the sucked air through a first discharge port; and
the exhaust guide member includes a guide plate forming a wall blocking between the first discharge port and the top space section.

7. The cooking appliance according to claim 6, wherein:
the guide plate forms an inclined wall blocking between the first discharge port and the top space section, and between the top space section and the exhaust port;
with respect to an up and down direction, the exhaust port is disposed at an upper side of the first discharge port, a lower end of the guide plate is disposed between the first discharge port and the exhaust port, and an upper end of the guide plate is disposed at an upper side of the exhaust port; and
with respect to a front and rear direction, the first discharge port is disposed at a front side of the exhaust port, the lower end of the guide plate is disposed at a front side of the first discharge port, and the upper end of the guide plate is disposed between the first discharge port and the exhaust port.

8. The cooking appliance according to claim 1, wherein:
the wind blowing part includes a rear fan assembly disposed at the rear space section;
the rear fan assembly sucks in air through a first suction port and discharges the sucked air through a first discharge port;
the rear guide flow path forms a passage connecting between the first discharge port and the exhaust port; and
the exhaust guide member includes a guide plate forming a wall defining an upper boundary surface of the rear guide flow path, a lower combining part combining the guide plate to the rear fan assembly, and an upper combining part combining the guide plate to the main body.

9. The cooking appliance according to claim 8, wherein the first discharge port is formed at a top surface of the rear fan assembly, and the lower combining part is combined to the rear fan assembly at an upper side and a front side of the first discharge port.

10. The cooking appliance according to claim 9, further comprising:
a fastening plate opening the first discharge port upward and combined to the top surface of the rear fan assembly; and
a fastening member penetrating through the top surface of the rear fan assembly and the fastening plate and the lower combining part together, and fastening the fastening plate and the lower combining part to the top surface of the rear fan assembly.

11. The cooking appliance according to claim 8, wherein the exhaust port is formed at the rear surface of the main body, and the upper combining part is combined to the rear surface of the main body at the upper side of the exhaust port.

12. The cooking appliance according to claim 8, further comprising an adapter configured to be combined with a duct to be connected to the exhaust port, wherein:
the adapter is combined to the rear surface of the main body at the outside of the exhaust port;
the rear surface of the main body and the adapter are disposed in a front and rear direction; and
the upper combining part is fixed between the rear surface of the main body and the adapter.

13. The cooking appliance according to claim 12, wherein the adapter is combined to the rear surface of the main body at a lateral outside of the exhaust port, and wherein the upper combining part is fitted between the rear surface of the main body and the adapter at the upper side of the exhaust port.

14. The cooking appliance according to claim 1, wherein:
the exhaust guide member includes a guide plate disposed at the rear space section, and an upper combining part combining the guide plate to the main body;
the exhaust port is formed at the rear surface of the main body; and
the upper combining part extends upward from the guide plate, protrudes toward the back side of the main body through the exhaust port, and is combined to the rear surface of the main body at the upper side of the exhaust port and the back side of the main body.

15. The cooking appliance according to claim 14, wherein:
the exhaust guide member further includes a side plate extending from the guide plate in a lateral direction;
in an upper side of the side plate, there is provided a notch;
the notch is formed as a space surrounded by an upper end of the side plate and a side end of the upper combining part; and
in the vertical plane formed by the rear surface of the main body, the notch is disposed at the outside of the exhaust port.

16. The cooking appliance according to claim 1, wherein:
the wind blowing part includes a rear fan assembly disposed at the rear space section, and a corner fan assembly disposed spaced apart from the rear fan assembly by a predetermined distance in a lateral direction;
the rear fan assembly sucks in air through a first suction port, and discharges the sucked air upward through a first discharge port;
at least a portion of the exhaust port is disposed at the lateral center of the main body; and
the lateral center of the exhaust port is disposed between the lateral center of the rear fan assembly and the corner fan assembly, or the lateral center of the rear fan assembly is disposed at a position offset from the lateral center of the exhaust port in a direction away from the corner fan assembly.

17. The cooking appliance according to claim 16, wherein:
with respect to a lateral direction, at least a portion of the rear fan assembly and the corner fan assembly are disposed outside the exhaust port;
the corner fan assembly is disposed at one lateral side of the exhaust port; and
at least a portion of the rear fan assembly is disposed at the lateral outside of the exhaust port, and is disposed at the other lateral side of the exhaust port.

18. The cooking appliance according to claim 17, wherein:
the rear guide flow path forms a passage connecting between the first discharge port and the exhaust port;
the exhaust guide member includes a guide plate forming a wall defining the upper boundary surface of the rear guide flow path, and an upper combining part combining the guide plate to the main body; and
a portion of the guide plate is disposed at the lateral outside of the exhaust port, and is disposed at the other lateral side of the exhaust port.

19. The cooking appliance according to claim 18, wherein with respect to a left and right direction, the guide plate is disposed at the inside of the rear fan assembly.

20. The cooking appliance according to claim 18, wherein:
a plurality of the first discharge ports are arranged in a lateral direction;
at least a portion of any one of the plurality of the first discharge ports is disposed at the lateral outside of the exhaust port, and is disposed at the other lateral side of the exhaust port;
the exhaust guide member is disposed at the upper side of the first discharge port; and
at least a portion of the exhaust guide member is disposed at the lateral outside of the exhaust port, and is disposed at the other lateral side of the exhaust port.
